(19) United States
(12) Patent Application Publication
(10) Pub. No.: US 2022/0404103 A1
(43) Pub. Date: Dec. 22, 2022

(54) METHOD AND APPARATUS FOR HEAT STORAGE

(71) Applicant: Graphite Energy (Assets) Pty Limited, Surry Hills, New South Wales (AU)

(72) Inventors: Saeid Seddegh, Carlingford, New South Wales (AU); Paul Soo-Hock Khoo, Castle Hill, New South Wales (AU); Jun Chao, North Ryde, New South Wales (AU); Byron Ross, Surry Hills, New South Wales (AU); Peter Lemmich, Surry Hills, New South Wales (AU); Casey Walsh, Surry Hills, New South Wales (AU)

(21) Appl. No.: 17/776,018

(22) PCT Filed: Dec. 1, 2020
(86) PCT No.: PCT/AU2020/051304

§ 371 Date: May 11, 2022

(30) Foreign Application Priority Data
Dec. 3, 2019 (AU) 2019904568

(51) Int. Cl. F28D 20/02; F28F 21/08; F28F 21/02

(52) U.S. Cl. CPC F28D 20/021; F28F 21/084; F28F 21/02; F28D 2020/0078

(57) ABSTRACT

The invention provides an energy storage apparatus comprising a crucible having a cavity and a channel, a phase change material stored in the cavity of the crucible and a heat exchanger having an inlet and an outlet, wherein at least a portion of the heat exchanger is disposed along the channel. Also provided are methods of reversibly storing and/or extracting energy, and an energy storage array comprising a plurality of energy storage apparatus as described above.

This application claims priority from Australian Provisional Patent Application No. 2019904568 filed 3 Dec. 2019, the contents of which should be understood to be incorporated.

### FIELD OF THE INVENTION

The present invention relates to an energy storage apparatus which can be used for high temperature applications such as generators. In particular, the present invention relates to an energy storage apparatus which can be operated at temperatures such that supercritical fluids such as air and CO₂ can be used for efficient electricity generation using, for example, turbo-expander generators and Brayton cycle generators.

In particular, the present invention relates to a graphite-based thermal energy storage apparatus for use with Brayton cycle generators and a method for storing thermal energy. However, it will be appreciated that the invention is not limited to these particular fields of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

As the world's population continues to increase, so too does the energy consumption required to power the daily lives of people and society. In order to meet this ever-increasing demand for energy, different technologies have been developed to generate energy such as coal, natural gas, nuclear and oil. Of particular interest has been the development of renewal energy technologies due to environmental concerns (such as reducing pollution and carbon dioxide emissions from coal and other fossil fuels). These renewal energy technologies include hydro, wind, solar, tidal and geothermal heat.

A particular issue of energy production from renewable energy sources is that they are intermittent sources. For example, wind turbines require string winds, solar power cannot be generated at night, hydro power generation is reduced severely during drought, and wave power is limited according to weather and sea conditions. As such, renewable technologies ideally require a method of storing the energy for later use.

One such approach to storing energy is to use battery technology such as lithium-ion batteries so that when on-demand production of electricity from a renewable source is unavailable, the energy demand can readily be met. However, battery technology can still be expensive for large-scale deployment and the energy capacity stored is limited and may not meet the energy demands when renewable energy production is delayed for long periods (such as when there are consecutive cloudy days for solar energy production, etc.).

As an alternative to battery technology, molten-salt technologies have been developed for storing energy. Molten salts can be employed as a thermal energy storage medium to retain thermal energy. This type of storage technology has been used commercially to store the heat collected by concentrated solar power (e.g., from a heliostat). The heat can then be converted into superheated steam to power conventional steam turbines and generate electricity as needed. The efficacy of various salt mixtures such as calcium nitrate, potassium nitrate and sodium nitrate, has been demonstrated.

In typical molten-salt energy storage systems for solar related applications, the salt melts at above 220° C. and is maintained as a liquid at about 280° C. The liquid salt is subsequently pumped into a solar collector where reflected and focussed sunrays heat the liquid salt to about 560° C. This heated liquid salt is then stored and when electricity is needed, the heated molten-salt is pumped through an external heat exchanger where heat from molten salt is extracted using water/steam.

Another energy storage medium is graphite. One form of graphite energy storage is embodied in a method and apparatus for collecting and/or storing thermal energy in graphite in a useable form. A variant is a method and apparatus for heating a body of graphite by induced eddy currents. Further, graphite may also be applied in a method for converting thermal energy in a block of graphite into electrical energy using a fluid such as steam.

Further iterations of graphite solar storage technology relate to a method and apparatus for collecting and/or storing thermal energy by heating an inner region of a body of graphite; a method and apparatus for recovering the heat from a body of graphite by way of a heat exchanger when the energy is required for use; and a method and apparatus for regulating the recovery of the thermal energy from the graphite.

Non-metallic phase change materials (PCMs) have also been used as an alternative to molten salts and graphite. Non-metallic PCMs include paraffins, salt hydrates and fatty acids. However, a major drawback of non-metallic PCMs for energy storage is that they are not suitable for high temperature applications (for example greater than about 600° C.).

The use of SiAl₁₂ and SiAl₂₀, for instance, is disclosed in international patent publication WO 2017/173499. In its broadest form, this document discloses an energy storage apparatus comprising: a casing; at least one crucible; at least one heating element adjacent the crucible; at least one heat conduit, having an inlet and outlet, adjacent the crucible; and a phase change material located within the at least one crucible, the phase change material selected from the group consisting of aluminium-silicon alloys, aluminium, magnesium chloride, sodium chloride and potassium chloride. In its preferred application, the storage device of WO 2017/173499 is used to convert liquid to gas (i.e., water to steam).

The apparatus of WO 2017/173499 appears unsuitable for storing high temperature thermal energy for use in high temperature applications such as supercritical carbon dioxide (sCO₂) Brayton cycle generators.

Given this limitation in the technology embodied by WO 2017/173499, it may be therefore desirable to develop an energy storage apparatus and a method for storing energy for use in high temperature applications for electricity generation such as sCO₂ Brayton cycle generators.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

The use of molten salts and non-metallic phase change materials have several advantages over the current state of the art, including long-term energy storage (up to weeks, months or even years), compatibility with different renewable energy sources and adaptability such that they can be used in any geographic location because they are not limited to locations having minimum sunlight, wind or tidal requirements.

However, as noted above in respect of WO 2017/173499 and competitor technologies, molten salts and non-metallic phase change materials for energy storage have been limited to lower temperature applications (up to 600° C.) as these materials are inherently not suitable for higher temperature applications (typically, solar related molten salts boil at 565° C.). As such, energy extraction for electricity generation from these materials are typically applied to steam turbines (by converting liquid water to steam).

The present Applicant has unexpectedly found that the use of a metallic phase change material can provide for higher temperature applications (up to 1500° C.) and can be used with Brayton cycle generators using supercritical CO₂ (i.e., no phase change in the fluid used) thereby being suitable for operating temperatures ranging from 350° C. to 1500° C., preferably 400° C. to 1000° C., more preferably 400° C. to 850° C.

### Energy Storage Apparatus

In one aspect, the present invention provides an energy storage apparatus comprising: a crucible having a cavity and a channel; a phase change material stored in the cavity of the crucible; and a heat exchanger having an inlet and an outlet, wherein at least a portion of the heat exchanger is disposed along the channel. Advantageously, the energy storage apparatus of the present invention provides combined latent and sensible energy storage.

In one embodiment, the energy storage apparatus is a thermal energy storage apparatus. In certain embodiments, the energy storage apparatus comprises a plurality of crucibles.

In certain embodiments, the present invention has at least one of the following advantages:
Suitable for high temperature applications for high pressure Brayton sCO₂ cycle generators;
Can use high temperature phase change materials;
Combination of sensible heat and latent heat storage;
Heating element can be internal or external to the crucible; and
Closed (optionally gas permeable) crucible containing high temperature phase change material. In some embodiments, the crucible components can be stacked to close the cavity of the crucible while still being gas permeable (i.e., not gas tight) to allow outgassing to escape and inert gas to enter crucible cavity.

In certain embodiments, the energy storage apparatus comprises a heating element. In preferred embodiments, the crucible has been adapted to receive a heating element, preferably by providing a heating element channel. In preferred embodiments, the crucible comprises a heating element disposed within the heating element channel. In this embodiment, the heating element is internal of the energy storage apparatus and more preferably internal of the crucible. Providing a heating element internal of the crucible can provide at least one of the following advantages: (a) reduce heat loss and improve the thermal efficiency of the energy storage apparatus; (b) reduce the number of heating elements required for a target temperature as the heating element surface watt density can be increased; (c) providing more uniform temperature profile during storage of thermal energy; (d) allows easier maintenance and/or repair by replacing heating elements as required; (e) faster heat up time of the energy storage apparatus; and (f) lower cost.

In some embodiments, two, three, four, five, six, seven, eight, nine, ten or more heating elements are provided. In some embodiments, twelve or more, fifteen or more, twenty or more, twenty five or more, thirty or more heating elements are provided. In some embodiments, the heating element is a resistor rack comprising individual electrical resistors. In other embodiments, the heating element is an electrical resistor.

In preferred embodiments, the phase change material is disposed between the heat exchanger and the heating element along at least one axis. In this embodiment, the phase change material advantageously provides a thermal barrier between the heating element and the heat exchanger to avoid overheating the heat exchanger and exceeding the heat exchanger materials temperature limit of operation. If a suitable phase change material having a melting temperature close to the maximum operating temperature of the heat exchanger material is chosen, the heat exchanger temperature rise rate can be slowed close to the maximum operating temperature limit making the heat exchanger temperature rise rate easier to control and can ensure that the maximum heat exchanger operating temperature is not exceeded.

Advantageously, the use of a metallic phase change material can provide higher operating temperatures such as from about 350° C. to about 1500° C., about 400° C. to about 1000° C., and even more preferably about 850° C. Accordingly, this can take advantage of the efficiency of Brayton cycle generators which typically have the greatest operational efficiency within this temperature range. Further, this higher temperature range is beyond molten-salt storage and non-metallic PCMs, which are the commercially-available PCM technologies characterising the state of the art.

At temperatures from about 400° C. to about 1000° C., supercritical fluids such as CO₂ (sCO₂) can be used (wherein no phase change occurs upon heating within this range). This allows for greater efficiencies when the energy storage apparatus is used in conjunction with an electrical generator such as a Brayton cycle generator. However, as will be appreciated, the energy storage apparatus of the present invention can be used with conventional turbines, turbo-expander generators and/or similar.

In some embodiments, the crucible comprises an open cavity. Advantageously, the crucible having an open cavity allows for the phase change material to expand in volume when heated and contract in volume when cooled.

In some embodiments, the crucible comprises a sealed closed cavity. In this configuration, the phase change material is enclosed and sealed gas-tight within the cavity. In other embodiments, the crucible comprises a gas-permeable closed cavity. In this configuration, the cavity is closed but allowing for gas exchange with the external environment. This provides outgassing while allowing inert gas to enter the cavity of the crucible storing the phase change material.

In some embodiments, the crucible comprises a plurality of cavities. In some embodiments, the crucible comprises two, three, four, five, six, seven, eight, nine, ten (or more) cavities. In certain embodiments, the cavity comprises at least one open cavity and at least one closed cavity. In other embodiments, all cavities may be closed, or all cavities may be open.

It should be appreciated by the skilled addressee that the cavity or cavities can take any geometry or size depending on the amount of phase change material to be stored. The cavity may take any suitable shape and may be for example in the shape of a sphere, cube, cylinder, cone, cuboid, prism, tetrahedron or an irregular shape.

In some embodiments, the crucible comprises one or more channels along the outer surface of the crucible body, wherein a portion of the heat exchanger is disposed along at least one of the one or more channels.

In preferred embodiments, the crucible comprises a channel having at least two open ends within the body of the crucible. In these configurations, a portion of the heat exchanger is encased within the channel of the crucible such that in use, a heat transfer medium can flow from the inlet to the outlet of the heat exchanger through the body of the crucible.

It should be appreciated by a skilled addressee that the channel can take any geometry or size depending on the flow rate required through the heat exchanger. In one embodiment, the channel is a recess. In other embodiments, the channel is tubular. In certain embodiments, the tubular channel has a cross-sectional shape selected from the group consisting of a circle, square, rectangular, ellipse, triangular, quadrilateral, pentagon, hexagon, nonagon, hexagon, heptagon, octagon or irregular shape. In preferred embodiments, the tubular channel is a circular or semi-circular channel. In some embodiments, the energy storage apparatus comprises a plurality of channels. In some embodiments, the energy storage apparatus comprises two, three, four, five, six, seven, eight, nine or more channels. In some embodiments, the plurality of channels are configured as independent circuits.

In some embodiments, the crucible is a unit body. That is, the crucible is a constructed from a single piece of material. In preferred embodiments, the crucible is assembled by component parts.

Suitable materials for the crucible include but are not limited to silicon carbide, graphite, reinforced polymer, clay, porcelain, ceramics, carbon nanotubes, aluminium nitride, aluminium oxide, boron nitride, silicon nitride, steel, copper, mullite, zirconium oxide, ductile iron, cast iron, stainless steel, brass, alloys of columbian, tantalum, molybdenum, tungsten and combinations thereof. It should be appreciated the crucible materials are not listed exhaustively above, but merely exemplify the types of materials that can be used depending upon the operating parameters selected.

In a preferred embodiment, the crucible is formed of graphite. In some embodiments, the graphite is crystalline, amorphous or a combination thereof. Graphite also has high thermal stability and electrical and thermal conductivity which makes it suitable for use as a refractory in high-temperature applications. In preferred embodiments, the graphite is used between ambient temperature up to 1000° C. and in preferred embodiments, the operational temperature is between about 400 to 850° C. Advantageously, the use of graphite as a crucible material is that it can be self-lubricating and also has dry lubricating properties. This provides improved compatibility with different materials of heat exchangers and can provide versatility due to modular construction.

In one embodiment, the crucible is formed of silicon carbide. Silicon carbide is composed of a crystal lattice of carbon and silicon atoms, and is able to provide structural integrity to the crucible. Silicon carbide is relatively inert in that it does not react with acids, alkali materials, or molten salts at temperatures up to 800° C. Further, silicon carbide forms a silicon oxide coating at 1200° C. which is able to withstand temperatures up to 1600° C. The crucible material therefore includes silicon oxide in one embodiment. Silicon carbide also has high thermal conductivity, low thermal expansion characteristics and high mechanical strength, and thus provides the crucible with relatively high thermal shock resistance qualities. It should be apparent that a crucible made of silicon carbide is resistant to chemical reactions, is suitably strong, and has good thermal conductivity which assists in heating the phase change material.

In some embodiments, the crucible has a density between about 1 g/cm³ and about 4 g/cm³, between about 1.5 g/cm³ and about 3.5 g/cm³, between about 2.0 g/cm³ and about 3.5 g/cm³, between about 2.5 g/cm³ and about 3.5 g/cm³, preferably between about 1.5 to 2.0 g/cm³.

The energy storage apparatus of the present invention is versatile as it can store energy using any suitable heating element (such as thermal or electrical heating element). Exemplary heating elements can be a heliostat, furnace, electrical resistor, or any other suitable means of achieving the operating temperatures embodying the invention. An alternative heating element is a heat transfer fluid which circulates within the crucible through the heat exchanger within the channel of the of crucible.

In one embodiment, the energy storage apparatus can store energy using electrical resistors which convert electrical energy to thermal energy to directly heat the crucible and phase change material. Alternatively, the energy storage apparatus can store energy using a thermal heating element. In this embodiment, the thermal heating element transfers energy to a heat transfer medium which heats the crucible and phase change material through the heat exchanger. In this embodiment, the heating element such as a heliostat or furnace can transfer energy to the heat transfer medium which heats the crucible and phase change material through the heat exchanger. In another alternative embodiment, the thermal heating element is a heat transfer fluid.

In certain embodiments, the heating element (such as a thermal or electrical heating element) for energy storage is external to the crucible. In preferred embodiments, the heating element is external to the energy storage apparatus. In some embodiments, a plurality of heating elements can be used external to the energy storage apparatus. In some embodiments, two, three, four, five, six, seven, eight, nine or more heating elements are provided. In some embodiments, the heating element is a resistor rack comprising individual electrical resistors. In other embodiments, the heating element is an electrical resistor.

It should be appreciated that the energy storage apparatus can be open to the atmosphere or closed (either sealed or gas-permeable) depending on the desired configuration and use. In preferred embodiments, the energy storage apparatus is sealed. This is because if the crucible is graphite, oxidation can occur in air at a temperature of about 450° C. and above. In certain embodiments, the energy storage apparatus is an air-tight seal. In preferred embodiments, the energy storage apparatus is sealed with air as the surrounding environment. In this embodiment, sealing with air is the most cost-effective approach.

In other embodiments, the energy storage apparatus is sealed using an inert gas. Suitable inert gases can be selected from the group consisting of nitrogen, argon, helium, neon, krypton, xenon, radon and combinations thereof. In preferred embodiments, the inert gas is nitrogen, argon, helium and combinations thereof. For cost reasons, nitrogen is most preferred. If a temperature of greater than 1000° C. is used, an inert gas selected from the group consisting of argon, helium and combinations thereof is preferred as nitrogen can form cyanide compounds above these temperatures. Advantageously, the use of inert gas when the energy storage apparatus is sealed can prevent or ameliorate unwanted reactions such as oxidation due to the high temperature environment of the crucible and can increase the lifespan of the energy storage apparatus.

As would be appreciated by a person skilled in the art, the heat exchanger can be of any geometry or material depending on the application and temperature required. In preferred embodiments, the shape of the heat exchanger will be complementary to the channel of the crucible such that the heat exchanger can fit in the channel and transfer energy to and/or from the crucible.

It should be appreciated that the energy storage apparatus can comprise a plurality of heat exchangers. In certain embodiments, the energy storage apparatus comprises two, three, four, five, six, seven, eight, nine, ten or more heat exchangers. In some embodiments, each heat exchanger is a separate independent circuit such that each heat exchanger can either be used to input energy or to extract energy as required.

In some embodiments, the heat exchanger is tubular. In certain embodiments, the tubular heat exchanger has a cross-sectional shape selected from the group consisting of a circle, square, rectangular, ellipse, triangular, quadrilateral, pentagon, hexagon, nonagon, hexagon, heptagon, octagon or irregular shape. In preferred embodiments, the tubular heat exchanger is a circular heat exchanger. In some embodiments, the heat exchanger comprises a fin (such as a wavy fin, a pin fin, a straight fin, a cross-cut fin, an elliptical fin or a honeycomb fin), a wire-mesh, or a combination thereof disposed on the surface of the heat exchanger. In some embodiments, the fin is a pin fin. In certain embodiments, the fins can be inline, staggered or a combination thereof.

In one embodiment, the material of the heat exchanger is an alloy, titanium or a ceramic. In some embodiments, the material of the heat exchanger is a superalloy or high temperature ceramic such as a refractory ceramic. Preferably, the material of the heat exchanger is resistant to oxidation or degradation at operating temperatures. In one embodiment, the material of the heat exchanger is selected from the group consisting of borides, carbides, nitrides, oxides of transition metals and combinations thereof. In one embodiment, the oxides of transition metals are selected from the group consisting of hafnium diboride, zirconium diboride, hafnium nitride, zirconium nitride, titanium carbide, titanium nitride, thorium dioxide, tantalum carbide and combinations thereof.

In certain embodiments, the material of the heat exchanger is a superalloy selected from the group consisting of a nickel based superalloy, cobalt based superalloy, iron based superalloy, chromium based superalloy and combinations thereof.

In certain embodiments, the superalloy is selected from the group consisting of titanium grade 2 alloy, TP439, Al29-40, Al2003, Al2205, Al2507, TP304, TP316, TP317, 254SMO, AL6XN, alloy, 309S, alloy 310H, alloy 321H, alloy 600, alloy 601, alloy 625, alloy 602CA, alloy 617, alloy 718, alloy 740H, alloy 230, alloy X, HR214, HR224, IN600, IN740, Haynes 282, Haynes 230, 347SS, 316L, AFA-006, C-276, P91/T122, 316SS, 1N601, IN800H/H, Hastelloy X, CF8C+, HR230, IN61, IN62, 253MA, 800H, 800HT, RA330, 353MA, HR120, RA333, and combinations thereof. In preferred embodiments, the material of the heat exchanger is alloy 625, alloy 740H, alloy 230, alloy 617, 800HT and combinations thereof. Non-limiting suitable alloy materials for heat exchangers are shown in Table 1.

TABLE 1
Potential heat exchanger materials

| Material | Composition (wt %)* | UNS No. | EN No. |
|---|---|---|---|
| Alloy 321H | 17-19 Cr, 9-12 Ni, 0.04-0.10 C, 2 Mn, 0.045 P, 0.03 S, | S32109 | 1.4878 |
| | 0.75 Si, 4 × (C + N) − 0.7 Ti, 0.10 N, Fe (balance) | | |
| Alloy 309S | 22-24 Cr, 12-15 Ni, 0.08 C, 2 Mn, 0.045 P, 0.03 S, 0.75 | S30908 | 1.4833 |
| | Si, 4 × (C + N) − 0.7 Ti, 0.10 N, Fe (balance) | | |
| Alloy 800H | 30-35 Ni, 19-23 Cr, 39.5 Fe, 0.05-0.10 C, 1.50 Mn, | N08810 | 1.4958 |
| | 0.045 P, 0.015 S, 1.0 Si, 0.15-0.60 Al, 0.15-0.60 Ti, 0.3- | | |
| | 1.2 Al + Ti | | |
| Alloy 800HT | 30-35 Ni, 19-23 Cr, 39.5 Fe, 0.06-0.10 C, 1.50 Mn, | N08811 | 1.4959 |
| | 0.045 P, 0.015 S, 1.0 Si, 0.25-0.60 Al, 0.25-0.60 Ti, | | |
| | 0.85-1.2 Al + Ti | | |
| Alloy 253MA | 0.05-012 C, 1.40-2.50 Si, 1.00 Mn, 0.045 P, 0.015 S, | S30815 | 1.4835 |
| | 20-22 Cr, 10-12 Ni, 0.12-0.20 N, 0.03-0.08 Ce, Fe | | |
| | (balance) | | |
| Alloy 310H | 24-26 Cr, 19-22 Ni, 0.04-0.10 C, 2 Mn, 0.045 P, 0.03 S, | S31009 | — |
| | 0.75 Si, Fe (balance) | | |
| Alloy RA330 | 17-20 Cr, 34-37 Ni, 0-2 Mn, 0.75-1.5 Si, 0-1 Cu, 0-0.03 | N08330 | 1.4886 |
| | P, 0-0.03 S, 0.04-0.08 C, Fe (balance) | | |
| Alloy 353MA | 37.18 Fe, 35 Ni, 25 Cr, 1.3 Ce, 1.3 Si, 0.17 N, 0.05 C | S35315 | 1.4854 |
| Alloy HR120 | 30-45 Ni, 12-32 Cr, 5 Co, 5 Mo, 4 Cb + Ta, 3 Si, 2 Mn, | N08120 | 2.4854 |
| | 0.2 C | | |
| Alloy RA333 | 44-47 Ni, 24-27 Cr, 2.5-4 Mo, 2.5-4 Co, 2.5-4 W, 0-0.08 | N06333 | 2.4608 |
| | C, 0.75-1.5 Si, 0-2 Mn, 0-0.03 P, 0-0.03 S, Fe (balance) | | |
| Alloy 625 | 58 min Ni, 20-23 Cr, 5 max Fe, 8-10 Mo, 3.15-4.15 | N06625 | 2.4856 |
| | Nb + Ta, 0.1 max C, 0.5 max Mn, 0.5 max Si, 0.015 max | | |
| | P, 0.015 S, 0.4 max Al, 0.4 max Ti, 1 Co | | |
| Alloy 600 | 72 min Ni + Co, 14-17 Cr, 6-10 Fe, 0.15 max C, 1 max | N06600 | 2.4816 |
| | Mn, 0.015 S, 0.5 Si, 0.5 Cu | | |
| Alloy 601 | 58-63 Ni, 21 -25 Cr, 16 Fe, 1-1.7 Al, 0.1 max C, 1.5 max | N06601 | 2.4851 |
| | Mn, 0.5 Si, 0.015 max S, 1 Cu | | |
| Alloy 602 CA | 24-26 Cr, 8-11 Fe, 0.15-0.25 C, 0-0.5 Mn, 0-0.5 Si, 0- | N06025 | 2.4633 |
| | 0.1 Cu, 1.8-2.4 Al, 0.1-0.2 Ti, 0.05-0.12 Y, 0.01-0.1 Zr, | | |
| | 0-0.02 P, 0-0.01 S, Ni (balance) | | |
| Alloy X | 0.05-0.15 C, 0-1 Mn, 0-0.04 P, 0-0.03 S, 0-1 Si, 20.5- | N06002 | 2.4665 |
| | 23 Cr, 8-10 Mo, 0-0.15 Ti, 0-0.5 Al, 17-20 Fe, 0-0.01 B, | | |
| | 0.5-2.5 Co, 0.2-1 W, 0-0.05 Cu, Ni (balance) | | |
| Alloy 617 | 44.5 min Ni, 20-24 Cr, 10-15 Co, 8-10 Mo, 0.8-1.5 Al, | N06617 | 2.4663a |
| | 0.05-0.15 C, 3 max Fe, 1 max Mn, 1 max Si, 0.015 max | | |
| | S, 0.6 max Ti, 0.5 max Cu, 0.006 max B | | |
| Alloy 230 | 57 (balance) Ni, 22 Cr, 14 W, 2 Mo, 3 max Fe, 5 max | N06230 | 2.4733 |
| | Co, 0.5 Mn, 0.4 Si, 0.5 max Nb, 0.3 Al, 0.1 max Ti, 0.1 | | |
| | C, 0.02 La, 0.015 max B | | |
| Alloy 740H | 23.5-25.5 Cr, 15-22 Co, 0.2-2 Al, 0.5-2.5 Ti, 0.5-2.5 Nb, | N07740 | — |
| | 0-3 Fe, 0.005-0.08 C, 0-1 Mn, 0-2 Mo, 0-1 Si, 0-0.5 Cu, | | |
| | 0-0.03 P, 0-0.03 S, 0.0006-0.006 B, Ni (balance) | | |
| Alloy C-276 | 57 (balance) Ni, 2.5 max Co, 16 Cr, 16 Mo, 5 Fe, 4 W, | N10276 | 2.4819 |
| | 1 max Mn, 0.35 max V, 0.08 max Si, 0.01 max C, 0.5 | | |
| | max Cu | | |
| Alloy 282 | 57 (balance) Ni, 20 Cr, 10 Co, 8.5 Mo, 2.1 Ti, 1.5 Al, 1.5 | N07208 | — |
| | max Fe, 0.3 max Mn, 0.15 max Si, 0.06 C, 0.005 B | | |

*slight composition variations may occur.

In some embodiments, the material of the heat exchanger is selected from the group consisting of silicon carbide, graphite, reinforced polymer, clay, porcelain, carbon nanotubes, aluminium nitride, aluminium oxide, boron nitride, silicon nitride, steel, mullite, zirconium oxide, ductile iron, cast iron, stainless steel, alloys of columbian, tantalum, molybdenum, tungsten and combinations thereof.

The phase change material of the present invention can be any suitable material which changes phase (i.e., solid, liquid, gas or plasma) when storing or extracting energy. Phase change materials are latent energy storage materials which can store or extract energy to change the state of a material at almost constant temperature when the material undergoes a phase change. For example, water is a latent energy storage material when undergoing a phase change during freezing and melting.

Preferred phase change materials include any metal, such as aluminium, zinc, lead, tin, magnesium, or an alloy containing any one or more of these metals. Most preferably, the phase change material is aluminium, or an alloy comprising aluminium, or a salt hydrate thereof.

Advantageously, use of a phase change material provides greater amounts of energy to be stored and extracted making them suitable for efficient energy storage systems which can store energy for extended periods of time. Further, depending on the crucible material and phase change material used, an energy storage apparatus comprising a combination of crucible and phase change material can lower capital costs as less crucible material is required and phase change materials are typically cheaper than the crucible material.

To avoid energy loss to the external environment, the energy storage apparatus can comprise insulation. The insulation can suitably be located on a surface of the crucible to minimise the amount of thermal energy lost to the external environment. The insulation can reduce the risk of an operator burning themselves during operation of the energy storage apparatus. In some embodiments, the insulation can comprise a plurality of insulation layers using different materials.

Suitable materials for the insulation can be selected from the group consisting of thermal insulation boards, alkaline earth silicate wool, thermal insulation blanks, fiberglass, mineral wool, polymers, and foams. For example, multiple layers of Carbolane or Superwool® blankets (Morgan Advanced Materials) and boards, of different specifications, can be used to prevent energy loss. It should also be appreciated that any insulation that is able to accommodate the high temperatures can be used in the energy storage apparatus.

In another aspect, the present invention provides a method of reversibly storing and/or extracting energy comprising the steps of:
heating a phase change material to induce a phase change thereby storing latent energy; and
extracting energy by flowing a heat transfer medium having a temperature below a temperature of the phase change material such that energy is transferred from the phase change material to the heat transfer medium, thereby providing reversible energy storage and extraction.

In one embodiment, the temperature of the heat transfer medium is below the phase change temperature of the phase change material. In preferred embodiments, the heat transfer medium is a heat transfer fluid (HTF).

In a further aspect, the present invention provides a method of reversibly storing and/or extracting energy comprising the steps of:
heating a crucible comprising a phase change material to induce a phase change thereby storing energy; and
extracting energy by flowing a heat transfer medium along the crucible having a temperature below a temperature of the phase change material such that energy is transferred from the phase change material to the heat transfer medium,

thereby providing reversible energy storage and extraction.

In one embodiment, the temperature of the heat transfer medium is below the phase change temperature of the phase change material. In preferred embodiments, the heat transfer medium is a heat transfer fluid.

In one embodiment, the method comprises heating the crucible of the energy storage apparatus to heat the phase change material. In another embodiment, the heat transfer medium does not undergo a phase change during extraction of energy.

In yet another aspect, the present invention provides an energy storage array comprising: a plurality of energy storage apparatus as described herein. Each apparatus is preferably held in thermal, fluid and/or electrical communication with at least one adjacent apparatus.

In an embodiment, the array is in the form of a module. Preferably, the module is assembled piecewise. Preferably, the module is contained within a housing. In an embodiment, the housing is a shipping container or the like. In another embodiment, the interior of the shipping container has been adapted to receive a plurality of energy storage apparatus (i.e., plurality of graphite panels, where each energy storage apparatus is typically one graphite panel) as described herein. In one embodiment, the plurality of apparatus are arranged in series or parallel. In one embodiment, a 20 foot shipping container houses 8 graphite panels and 7 resistor racks comprising about 35 electrical resistors. In a preferred embodiment, a 20 foot shipping container houses two graphite panels comprising 32 heaters per panel.

In other embodiments, the housing can be sealed and/or insulated as described above.

Advantageously, the modular approach of using an energy storage array provides control of the total energy which can be stored and extracted to meet a variety of energy demands.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The term ‘substantially’ as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference.

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### BRIEF DESCRIPTION OF THE DRAWINGS

Preferred embodiments of the invention will now be described, by way of example only, with reference to the accompanying drawings in which:

FIG. 1 shows an embodiment of the energy storage apparatus of the present invention. a) side perspective view; b) cross-sectional perspective view taken along the line A-A of FIG. 1a; and c) top view, in which the heat exchange tubing/piping is kept isolated from the phase change material.

FIG. 2a shows a perspective view of an energy storage array using electrical heating elements; and FIG. 2b shows a perspective view of thermal heating (no elements) through a heat exchanger.

FIG. 3a shows an embodiment of an energy storage apparatus having a heating element channel internally of the crucible. FIG. 3b shows a front view of the embodiment of FIG. 3a. FIG. 3c shows an embodiment of a deep and shallow cavity crucible component, respectively.

FIG. 4 shows a representative example of the implementation of the modules comprising the energy storage apparatus of the present invention in an overall system with grid connection.

FIG. 5 shows volume ratio comparison of aluminium energy storage at different temperatures (a) stored thermal energy (kWh/tonne) vs aluminium volume (%) between about 400-800° C.; and (b) stored thermal energy (kWh/tonne) vs aluminium volume (%) between about 400-1000° C.

FIG. 6 shows volume ratio comparison of energy storage using aluminium between a temperature of about 400-800° C. and about 400-1000° C. at different relative amounts of aluminium to graphite (wt %).

FIG. 7 shows the temperature of the heat exchanger as an embodiment of the energy storage apparatus is being charged. (a) the heater temperature is set at maximum of 700° C. and total power of 522 kW. Maximum heat exchanger pipe temperature of 675° C. is reached after 5 hours of charging; and (b) heater temperature is set at maximum of 800° C. and total power of 522 kW. Maximum heat exchanger pipe temperature of 675° C. is reached under 3 hours of charging with no aluminium PCM. However, with aluminium PCM the temperature rise slope flattens allowing more time for the heater controls to respond.

FIG. 8 shows photographs of the kiln setup (a) exterior of kiln with a controller prior to door sealing improvements and ceramic thermocouple installation; (b) interior of kiln showing temperature control and auxiliary thermocouples; and (c) configuration showing testing of phase change material in a graphite crucible.

FIG. 9 shows heating and cooling traces of phase change material (aluminium) in graphite crucible. FIG. 9 shows a clear ‘knee’ in the heat and cool traces for the PCM at the expected temperature of ˜679° C.

FIG. 10 shows heating and cooling temperature curves using a 20 mm thick aluminium plate to observe the behaviour of solid aluminium pieces as phase change material and further to verify argon flow (3 L/min) and oxygen sensing. A clear knee temperature on heating and cooling of ˜640° C. was observed.

FIG. 11 shows five tests of heating and cooling of an aluminium rod in graphite crucible performed over two weeks showing consistent melting point of aluminium phase change material.

### DETAILED DESCRIPTION OF THE INVENTION

The skilled addressee will understand that the invention comprises the embodiments and features disclosed herein as well as all combinations and/or permutations of the disclosed embodiments and features.

The Applicant has unexpectedly found that the use of a metallic phase change material can provide for higher temperature applications (up to about 1000° C.) and can be used with Brayton cycle generators using supercritical CO₂ (i.e., no phase change in the fluid used) thereby being suitable for operating temperatures ranging from about 400° C. to about 1000° C., preferably between about 400° C. to about 850° C. This represents a significant advance over the state of the art, which were inherently limited to lower temperature operation by the use of conventional materials.

In one form, the present invention provides a method of reversibly storing energy comprising the steps of: heating a phase change material to induce a phase change thereby storing latent energy; and extracting energy by flowing a heat transfer medium having a temperature below a temperature of the phase change material such that energy is transferred from the phase change material to the heat transfer medium, thereby providing reversible energy storage and extraction.

In a further form, the present invention provides a method of reversibly storing energy comprising the steps of: heating a crucible comprising a phase change material to induce a phase change thereby storing energy; and extracting energy by flowing a heat transfer medium along the crucible having a temperature below a temperature of the phase change material such that energy is transferred from the phase change material to the heat transfer medium, thereby providing reversible energy storage and extraction.

Advantageously, use of a phase change material provides greater amounts of energy to be stored and extracted making them suitable for efficient energy storage systems which can store energy for extended periods of time.

In one embodiment, the temperature of the heat transfer medium is below the phase change temperature of the phase change material.

In one embodiment, the method comprises heating the crucible of the energy storage apparatus to heat the phase change material. In another embodiment, the heat transfer medium does not undergo a phase change during extraction of energy. In certain embodiments, the storing step (by for example heating) and extraction step (for electricity generation) can be performed simultaneously.

In one embodiment, the phase change material has a phase change temperature up to about 1500° C., up to about 1300° C., up to about 1200° C., or up to about 1000° C. In one embodiment, the phase change material has a phase change temperature between about 80 to about 1500° C., between about 200 to about 1500° C., preferably between about 350 to about 1200° C., preferably between about 500 to about 1500° C., preferably between about 800 to about 1200° C., preferably between about 400 to about 1000° C., more preferably between about 400 to about 850° C., more preferably between about 400 to about 800° C., more preferably between about 550 to about 1000° C. and most preferably between about 600 to about 800° C. The use of a phase change material can increase the cost effectiveness of storing energy.

The energy storage apparatus can comprise any suitable amount of phase change material relative to the total volume (v/v %) of the energy storage apparatus. In some embodiments, the phase change material is at least about 10 v/v %, at least about 20%, at least about 30 v/v %, at least about 40 v/v %, at least about 50 v/v %, at least about 60 v/v %, at least about 70 v/v %, at least about 80 v/v %, at least about 90 v/v % of the total volume of the energy storage apparatus. In some embodiments, the phase change material is less than about 10 v/v %, less than about 20 v/v %, less than about 30 v/v %, less than about 40 v/v %, less than about 50 v/v %, less than about 60 v/v %, less than about 70 v/v %, less than about 80 v/v %, less than about 90 v/v % of the total volume of the energy storage apparatus. In some embodiments, the phase change material is between about 10 to about 90 v/v %, between about 10 to about 80 v/v %, between about 10 to about 70 v/v %, between about 10 to about 60 v/v %, between about 10 to about 50 v/v %, between about 10 to about 40 v/v % between about 10 to about 30 v/v %, and more preferably about 20 v/v % or about 30 v/v % of the total volume of the energy storage apparatus. In preferred embodiments, the phase change material is between about 10 to about 35 v/v %, more preferably about 15 to about 30 v/v % of the total volume of the energy storage apparatus.

In certain embodiments, the thermal conductivity of the phase change material is between about 1 to about 300 W/m·K, between about 20 to about 300 W/m·K, between about 50 to about 300 W/m·K, between about 50 to about 250 W/m·K, between about 50 to about 220 W/m·K, more preferably between about 50 to about 200 W/m·K.

In certain embodiments, the latent heat of the phase change material is between about 20 to about 600 kJ/kg, between about 20 to about 500 kJ/kg, between about 20 to about 80 kJ/kg, between about 50 to about 400 kJ/kg, between about 50 to about 350 kJ/kg, between about 100 to about 350 kJ/kg, between about 150 to about 350 kJ/kg, between about 350 to about 450 kJ/kg, between about 200 to about 300 kJ/kg, preferably between about 300 to about 400 kJ/kg, preferably between about 150 to about 600 kJ/kg, preferably between about 200 to about 600 kJ/kg, preferably between about 300 to about 600 kJ/kg, more preferably between about 250 to about 600 kJ/kg.

In some embodiments, the phase change material has a heat of fusion greater than about 100 kJ/kg, between about 100 to about 1000 kJ/kg, between about 100 to about 700 kJ/kg, between about 350 to about 450 kJ/kg, preferably between about 300 to about 700 kJ/kg, preferably between about 450 to about 600 kJ/kg, preferably about 560 kJ/kg, and more preferably about 400 kJ/kg. Typically, the higher the heat of fusion, the better as more energy can be stored for a given volume of phase change material.

In one embodiment, the phase change material is an organic, inorganic or eutectic material. In one embodiment, the phase change material is a metal, metallic alloy, salt hydrate and combinations thereof. Advantageously, metallic phase change materials have high thermal conductivity and can improve the efficiency of energy charging, storage and extraction.

In some embodiments, the phase change material is selected from the group consisting of water, sodium sulfate, lauric acid, trimethylolethane, manganese nitrate, sodium silicate, aluminium, copper, gold, iron, lead, lithium, silver, titanium, zinc, sodium nitrate, sodium nitrite, sodium hydroxide, potassium nitrate, potassium hydroxide, sodium chloride, potassium chloride, lithium chloride, magnesium chloride, potassium bromide, paraffin 14 to 34-carbons, formic acid, caprylic acid, glycerine, p-lattic acid, methyl palmitate, camphenilone, docasyl bromide, caprylone, phenol, heptadecanone, 1-cyclohexylooctadecane, 4-heptadacanone, p-toluidine, alpha napthol, glautaric acid, p-xylene dichloride, benzoic acid and combinations thereof.

In certain embodiments, the phase change material is selected from the group consisting of aluminium, zinc, lead, tin, magnesium, silicon and alloys thereof. In preferred embodiments, the phase change material is selected from the group consisting of aluminium, zinc, zinc alloy, lead, lead alloy, tin, tin alloy, magnesium, magnesium alloy, silicon, silicon alloy and combinations thereof.

When the phase change material is an aluminium alloy, the alloy can comprise between about 1% and about 90% by weight of aluminium, between about 1% and about 80% by weight of aluminium, between about 1% and about 70% by weight of aluminium, between about 1% and about 60% by weight of aluminium, between about 1% and about 50% by weight of aluminium, between about 40% and about 60% by weight of aluminium, between about 5% and about 25% by weight of aluminium, preferably between about 10% and about 20% by weight of aluminium, and the balance being alloy.

When the phase change material is a zinc alloy, the alloy can comprise between about 1% and about 90% by weight of zinc, between about 1% and about 80% by weight of zinc, between about 1% and about 70% by weight of zinc, between about 1% and about 60% by weight of zinc, between about 1% and about 50% by weight of zinc, between about 5% and about 25% by weight of zinc, preferably between about 10% and about 20% by weight of zinc, and the balance being alloy.

When the phase change material is a lead alloy, the alloy can comprise between about 1% and about 90% by weight of lead, between about 1% and about 80% by weight of lead, between about 1% and about 70% by weight of lead, between about 1% and about 60% by weight of lead, between about 1% and about 50% by weight of lead, between about 5% and about 25% by weight of lead, preferably between about 10% and about 20% by weight of lead, and the balance being alloy.

When the phase change material is a tin alloy, the alloy can comprise between about 1% and about 90% by weight of tin, between about 1% and about 80% by weight of tin, between about 1% and about 70% by weight of tin, between about 1% and about 60% by weight of tin, about 1% and about 50% by weight of tin, between about 5% and about 25% by weight of tin, preferably between about 10% and about 20% by weight of tin, and the balance being alloy.

When the phase change material is a magnesium alloy, the alloy can comprise between about 1% and about 90% by weight of magnesium, between about 1% and about 80% by weight of magnesium, between about 1% and about 70% by weight of magnesium, between about 1% and about 60% by weight of magnesium, between about 1% and about 50% by weight of magnesium, between about 5% and about 25% by weight of magnesium, preferably between about 10% and about 20% by weight of magnesium, and the balance being alloy.

In one embodiment, the phase change material is an aluminium silicon alloy, comprising 12% by weight of aluminium (i.e., known as AlSi12). Also suitable is AlSi20 which contains 20% by weight aluminium.

AlSi12 has a melting temperature of about 576° C. and a heat of fusion of about 560 kJ/kg, and AlSi20 has a melting temperature of about 585° C. and a heat of fusion of about 460 kJ/kg. Table 2 shows the physical properties of AlSi12, and it should be clear that the heat of fusion of AlSi12 is many magnitudes greater than the specific heat capacity of AlSi12.

TABLE 2
Thermal Physical Properties of AlSi12

| | |
|---|---|
| Specific heat for solid state, kJ/kgK | 1.038 |
| Specific heat for liquid state, kJ/kgK | 1.741 |
| Phase change temperature, ° C. | 576 |
| Heat of fusion, kJ/kg | 560 |
| Density, kg/m³ | 2700 |
| Thermal conductivity, W/M ° C. | 160 |

Other suitable phase change materials can be selected from the group consisting of 59Al/35Mg/6Zn, 60Mg/25Cu/15Zn, 52Mg/25Cu/23Ca, 54Al/22Cu/18Mg/6Zn, 65Al/30Cu/5Si, 46.3Mg/53.7Zn, 96Zn/4Al, 86.4Al/9.4Si/4.2Sb, 34.65Mg/65.35Al, 60.8Al/33.2Cu/6Mg, 64.1Al/5.2Si/28Cu/2.2Mg, 68.5Al/5Si/26.5Cu, 64.3Al/34Cu/1.7Sb, 66.92Al/33.08Cu, 83.12Al/11.7Si/5.16Mg, 87.76Al/12.24Si, 46.3Al/4.6Si/49.1Cu, 88Al/12Si and combinations thereof. The amounts of the respective components of the alloys are w/w %, not stoichiometric ratios.

It will be appreciated that the alloys can comprise, additional elements such as iron, copper, manganese, magnesium, lead, nickel, zinc, titanium, tin, strontium, chromium and the like as impurities.

The list of phase change materials is not an exhaustive list and merely exemplifies certain examples of the phase change material.

Physical properties of various phase change materials are provided in Tables 3 through 8.

TABLE 3
Comparison of phase change material with graphite

| | | Aluminium | Zinc | Lead | Tin |
|---|---|---|---|---|---|
| | | (660° C.) | (420° C.) | (327° C.) | (232° C.) |
| | Graphite | boiling at | boiling at | boiling at | boiling at |
| | (3600° C.) | 2500° C. | 907° C. | 1750° C. | 2600° C. |
| Density | 1.70 | 2.70 | 7.13 | 11.34 | 7.28 |
| (ton/m³) | | | | | |
| Specific heat | 1.75 | 0.91 | 0.39 | 0.13 | 0.21 |
| capacity (Cp, | | | | | |
| kJ/kg · K) | | | | | |
| Latent heat | NA | 398 | 113 | 23 | 59 |
| (kJ/kg) | | | | | |
| Thermal | 60-120 | Solid: 206, | 105 | Solid: 34, | 62 |
| conductivity | | Liquid: 92 | | Liquid: 31 | |
| (W/m · k) | | | | | |

TABLE 4
storage comparison of phase change materials

| Heat capacity | | Graphite | Aluminium | Zinc | Lead | Tin |
|---|---|---|---|---|---|---|
| Q = 1000 MJ | | (3600° C.) | (660° C.) | (420° C.) | (327° C.) | (232° C.) |
| | ΔT | Required mass (tonne) of material | | | | |
| 200-700° C. | 500 | 1.14 | 1.17 | 3.26 | 11.36 | 6.10 |
| 200-600° C. | 400 | 1.43 | 2.75 | 3.73 | 13.33 | 6.99 |
| 200-500° C. | 300 | 1.90 | 3.66 | 4.36 | 16.13 | 8.20 |
| 200-400° C. | 200 | 2.86 | 5.49 | 12.89 | 20.41 | 9.90 |
| 200-300° C. | 100 | 5.71 | 10.99 | 25.77 | 76.92 | 12.50 |

TABLE 5
Cost ratio of energy storage

| Heat capacity | | Graphite | Aluminium | Cost ratio^{a} (%, |
|---|---|---|---|---|
| Q = 1000 MJ | | Required mass | | aluminium storage/ |
| | ΔT | (tonne) of material | | graphite storage) |
| 200-700° C. | 500 | 1.14 | 1.17 | 51 |
| 200-600° C. | 400 | 1.43 | 2.75 | 96.2 |
| 200-500° C. | 300 | 1.90 | 3.66 | 96.3 |
| 200-400° C. | 200 | 2.86 | 5.49 | 96 |
| 200-300° C. | 100 | 5.71 | 10.99 | 96.2 |

^{a}Assuming aluminium is half the price of graphite, which is historically appropriate.

TABLE 6
Physical properties of metallic alloy phase change materials

| | Melting | Latent | | Specific heat |
|---|---|---|---|---|
| | temperature | heat | Density | capacity (Cp, |
| Alloy (wt %) | (° C.) | (kJ/kg) | (tonne/m³) | kJ/kg · K) |
| 59Al/35Mg/6Zn | 443 | 310 | 2.38 | 1.63 |
| 60Mg/25Cu/15Zn | 452 | 254 | 2.8 | 1.5 |
| 52Mg/25Cu/23Ca | 453 | 184 | 2 | 1.5 |
| 54Al/22Cu/18Mg/6Zn | 520 | 305 | 3.14 | 1.51 |
| 65Al/30Cu/5Si | 571 | 422 | 2.73 | 1.3 |

TABLE 7
Storage comparison of metallic alloy phase change materials

| Heat capacity | | | | | | | | |
|---|---|---|---|---|---|---|---|---|
| Q = 1000 MJ | | Graphite | Aluminium | 59Al/35Mg/6Zn | 60Mg/25Cu/15Zn | 52Mg/25Cu/23Ca | 54Al/22Cu/18Mg/6Zn | 65Al/30Cu/5Si |
| | ΔT | Required mass (tonne) of material | | | | | | |
| 200-700° C. | 500 | 1.14 | 1.17 | 0.89 | 1.00 | 1.07 | 0.94 | 0.93 |
| 200-600° C. | 400 | 1.43 | 2.75 | 1.04 | 1.17 | 1.28 | 1.10 | 1.06 |
| 200-500° C. | 300 | 1.90 | 3.66 | 1.25 | 1.42 | 1.58 | 2.21 | 2.56 |
| 200-400° C. | 200 | 2.86 | 5.49 | 3.07 | 3.33 | 3.33 | 3.31 | 3.85 |
| 200-300° C. | 100 | 5.71 | 10.99 | 6.13 | 6.67 | 6.67 | 6.62 | 7.69 |

TABLE 8
Alternative metallic alloy phase change materials

| | Melting temperature | Latent heat |
|---|---|---|
| Alloy (wt %) | (° C.) | (kJ/kg) |
| 46.3Mg/53.7Zn | 340 | 185 |
| 96Zn/4Al | 381 | 138 |
| 86.4Al/9.4Si/4.2Sb | 471 | 471 |
| 34.65Mg/65.35Al | 497 | 285 |
| 60.8Al/33.2Cu/6Mg | 506 | 356 |
| 64.1 Al/5.2Si/28Cu/2.2Mg | 507 | 374 |
| 68.5Al/5Si/26.5Cu | 525 | 364 |
| 64.3Al/34Cu/1.7Sb | 545 | 331 |
| 66.92Al/33.08Cu | 548 | 372 |
| 83.12Al/11.7Si/5.16Mg | 555 | 485 |
| 87.76Al/12.24Si | 557 | 498 |
| 46.3Al/4.6Si/49.1Cu | 571 | 406 |
| 88Al/12Si | 576 | 560 |

In certain embodiments, the phase change of the phase change material can be between gaseous-liquid states, solid-liquid states and solid-gaseous states.

As would be appreciated by a person skilled in the art, the heat transfer medium of the present invention can be any suitable medium which can transfer energy with the phase change material. In some embodiments, the heat transfer medium is a liquid, gas, solid, supercritical fluid, plasma or combination thereof.

In one embodiment, the heat transfer medium is a supercritical fluid such as air or supercritical carbon dioxide, preferably supercritical carbon dioxide. In preferred embodiments, the heat transfer medium does not change phase when storing or extracting energy. In these embodiments, the heat transfer medium can be used for high temperature applications such as Brayton cycle generators which have operating temperatures ranging from about 400° C. to about 1000° C.

As no phase change of the heat transfer medium occurs when using a supercritical fluid, higher energy transfer efficiencies and use in higher temperature applications are suitable.

In some embodiments, the heat transfer fluid is selected from the group consisting of liquid sodium (Na); liquid potassium (K), liquid NaK, liquid tin (Sn), liquid lead (Pb), liquid lead-bismuth (PbBi) and combinations thereof. In some embodiments, the heat transfer fluid is selected from the group consisting of liquid sodium (Na); liquid potassium (K), liquid NaK (77.8% K), liquid tin (Sn), liquid lead (Pb), liquid lead-bismuth (PbBi) (45%/55%) and combinations thereof.

In certain embodiments, the heat transfer medium is selected from the group consisting of water, supercritical carbon dioxide, compressed air, compressed nitrogen, organic fluids (such as thermal oils including Dowtherm A), salt hydrates, liquid metals (such as mercury and potassium) and combinations thereof.

Additives such as ethylene glycol, diethylene glycol, propylene glycol, betaine, hexamine, phenylenediamene, dimethylethanolamine, sulphur hexafluoride, benzotriazole, zinc dithiophosphates, nanoparticles, polyalkylene glycols and combinations thereof can be added or mixed with the heat transfer medium to inhibit corrosion, alter the viscosity and enhance thermal capacity.

The flow rate of the heat transfer medium can be at any suitable rate which is sufficient to transfer energy between the heat exchanger and phase change material. In certain embodiments, the flow rate of the heat transfer medium per crucible is between about between about 5 to about 500 L/min, between about 5 to about 300 L/min, between about 5 to about 200 L/min, between about 100 to about 500 L/min, between about 200 to about 500 L/min, between about 300 to about 500 L/min, 5 to about 100 L/min, between about 5 to about 80 L/min, between about 10 to about 80 L/min, between about 20 to about 60 L/min and preferably between about 20 to about 50 L/min.

In certain embodiments, the flow rate of the heat transfer medium per crucible is between about between about 5 to about 500 kg/min, between about 5 to about 300 kg/min, between about 5 to about 200 kg/min, between about 200 to about 300 kg/min, between about 100 to about 500 kg/min, between about 200 to about 500 kg/min, between about 300 to about 500 kg/min, 5 to about 100 kg/min, between about 5 to about 80 kg/min, between about 10 to about 80 kg/min, preferably between about 20 to about 60 kg/min, preferably between about 30 to about 60 kg/min, between preferably about 20 to about 40 kg/min and preferably about 50 to about 70 kg/min.

Depending on the flow rate and heat transfer medium used, the energy transfer rates for storing or extracting energy (for example, energy transfer rate to the phase change material or to the heat transfer medium) can be adjusted as required. In some embodiments, the energy transfer rate is between about 5 to about 100° C./min, between about 5 to about 80° C./min, between about 5 to about 60° C./min, between about 5 to about 50° C./min and more preferably between about 5 to about 30° C./min.

In some embodiments, the heat transfer medium has an increase in temperature as a result of extracting energy from the phase change material of between about 10 to about 800° C., between about 50 to about 800° C., between about 100 to about 800° C., between about 100 to about 800° C., between about 100 to about 700° C., between about 100 to about 600° C., between about 100 to about 300° C., between about 200 to about 500° C., preferably between about 100 to about 300° C. compared to the temperature prior to extraction of energy.

In some embodiments, the heat transfer fluid is a working fluid. In preferred embodiments, the working fluid is supercritical CO₂. As would be understood by a skilled addressee, a heat transfer fluid is a medium (such as a gas or liquid) which allows passive transfer of energy, typically, thermal energy. As would be understood by a skilled addressee, a working fluid is a medium (such as a gas or liquid) that primarily transfers force, motion, or mechanical energy. Typically, the working fluid converts thermal energy to mechanical energy such as supercritical CO₂ to power a Brayton cycle generator or turbine to generate electricity.

In certain embodiments, the working fluid has an operating temperature ranging between about 400° C. to about 1000° C., between about 400° C. to about 850° C., between about 500° C. to about 800° C., between about 400° C. to about 775° C. and between about 400° C. to about 675° C.

In certain embodiments, the working fluid has an operating pressure ranging between about 50 Bar to about 500 Bar (about 5 MPa to about 50 MPa), between about 100 Bar to about 400 Bar (about 10 MPa to about 40 MPa), between about 150 Bar to about 300 Bar (about 15 MPa to about 30 MPa), between about 200 Bar to about 300 Bar (about 20 MPa to about 30 MPa), between about 200 Bar to about 260 Bar (about 20 MPa to about 26 MPa), more preferably between about 220 Bar to about 270 Bar (about 22 MPa to about 27 MPa), yet more preferably about 250 Bar (about 25 MPa). In certain embodiments, the working fluid has an operating temperature ranging between about 400° C. to about 775° C. at 250 Bar (about 25 MPa) and more preferably between about 400° C. to about 675° C. at 250 Bar (about 25 MPa).

In yet another form, the present invention provides an energy storage array comprising: a plurality of energy storage apparatus as described herein. Advantageously, the energy storage array can be readily transported to a desired site for energy storage. For instance, where the array is housed within a shipping container, the resultant module is readily transportable by road, rail, sea or the like.

In some embodiments, the energy storage apparatus can be configured in parallel or in series. In one embodiment, the heating element is external to the energy storage apparatus.

It should be appreciated that the energy storage array can comprise any number of energy storage apparatus as required. In certain embodiments, the energy storage array comprises two, three, four, five, six, seven, eight, nine, ten or more energy storage apparatus. In preferred embodiments, the energy storage array comprises eight energy storage apparatus.

### EXAMPLES

### Example 1—Crucible

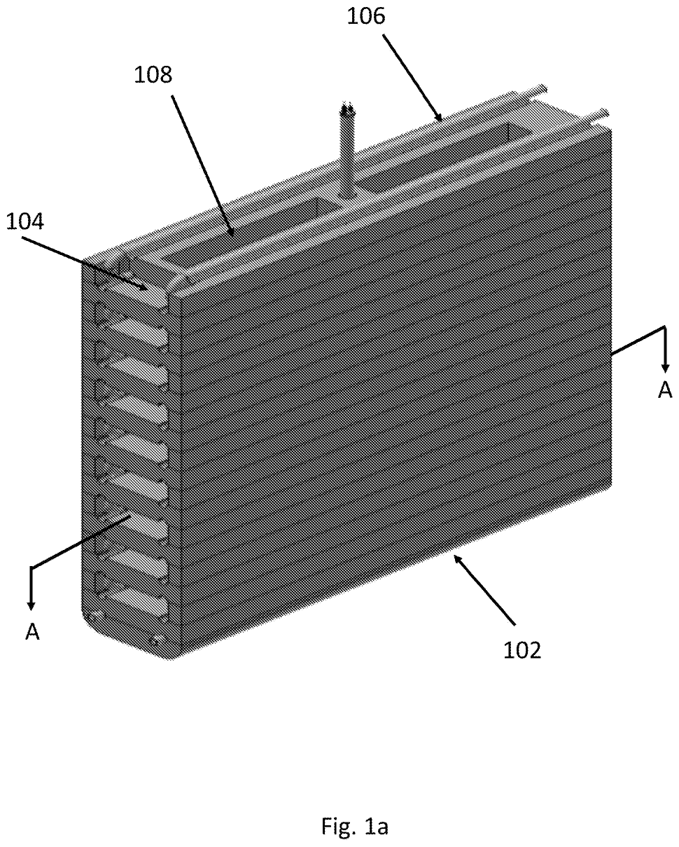

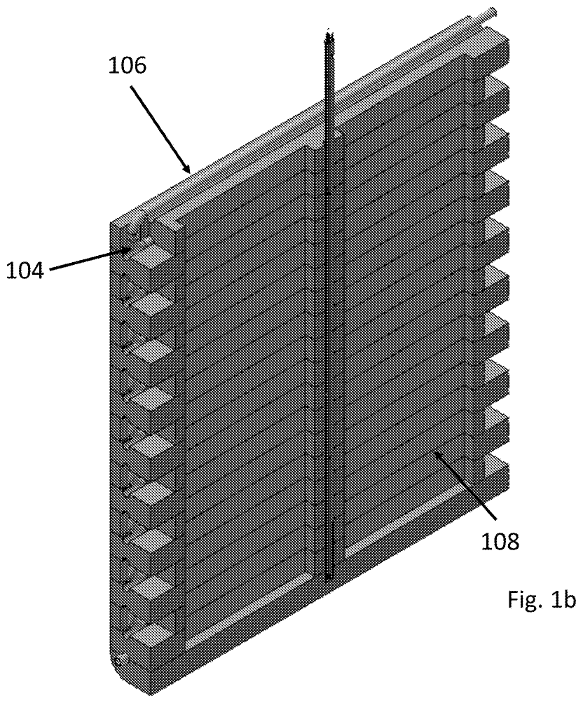

Referring to FIGS. 1a-c, there is shown a crucible 102 for use in an energy apparatus 100 (not shown). The crucible 102 has a channel 104 disposed in the outer surface of the crucible body 102, where a portion of the heat exchanger 106 is disposed along the channel. The crucible 102 has two cavities 108 for storing the phase change material 110 (not shown). The heat exchanger 106 is isolated from the phase change material 110.

In an alternative configuration (not shown), a crucible 102 for use in an energy apparatus 100 having a channel 104 and having at least two open ends within the body of the crucible 102 can be used. In this configuration, a portion of the heat exchanger 106 is encased within the channel 104 of the crucible such that in use, a heat transfer medium can flow from the inlet to the outlet of the heat exchanger 106 through the body of the crucible 102.

### Example 2—Electrical Heating of Energy Storage Apparatus

For convenience, the numbering of the remaining Figures showing alternative configurations have been maintained as per FIG. 1.

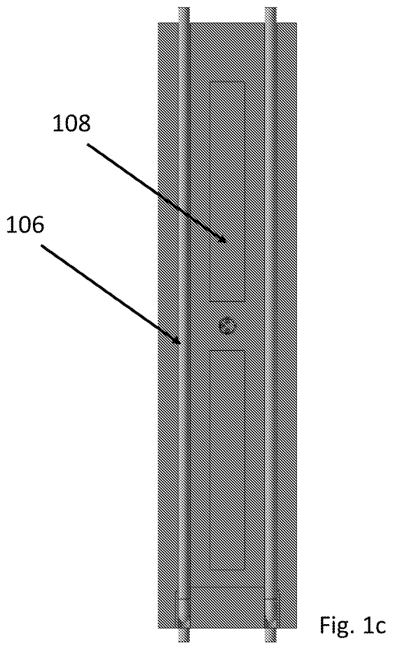

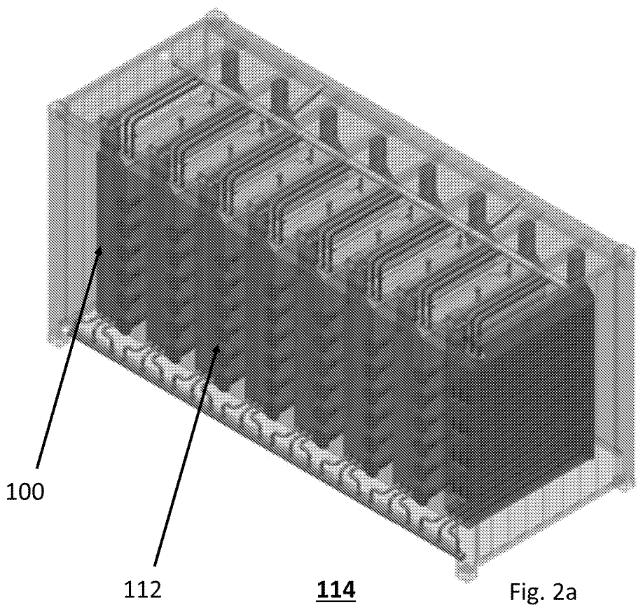

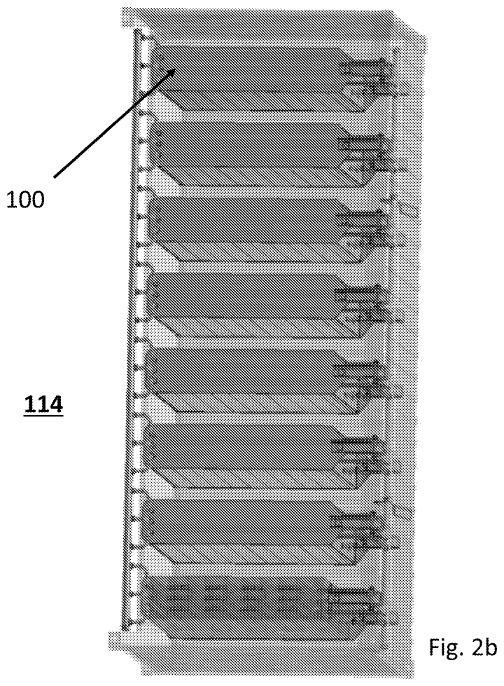

Referring to FIG. 2a, the energy storage apparatus 100 comprises a crucible 102 (not shown). A heating element 112 external to the energy storage apparatus 100 is placed in heating communication with the energy storage apparatus 100 to heat the crucible 102 and phase change material 110 (not shown). The heating element 112 is provided as a series of electrical resistors in a resistor rack (not shown). Of course, the alternative configuration wherein the heating element 112 is integral (not shown) with the energy storage apparatus is possible also.

The voltage of the heating element 112 is suitably between about 10 V and about 1000 V for each electrical resistor 112a, more suitably between about 20 V and about 600 V for each electrical resistor 112a, preferably between about 20 V and 500 V for each electrical resistor 112a, and most preferably between about 24 V and about 415 V for each electrical resistor 112a.

FIG. 2a shows an energy storage array 114 having eight energy storage apparatus 100 and seven resistor racks external to the energy storage apparatus 100. Each resistor rack has five electrical resistors. The energy storage array 114 can be used within a container such as a shipping container for easy transport.

The phase change material 110 is located within the crucible 102 such that when the crucible 102 is heated by the heating element 112, the thermal energy is transferred to the phase change material 110 to store energy. The heat exchanger 106 is encased within the crucible 102 so that it can extract the thermal energy from the phase change material 110 when required. The heat exchanger 106 can be a high pressure pipe network which facilitates storing and/or extraction of the thermal energy from the phase change material 110 and converting said thermal energy to electricity. The heat exchanger 106 has an inlet and an outlet. The inlet of the heat exchanger 106 is generally connected to a high pressure pump (not shown) and the outlet will generally be connected to a turbine (not shown). In this regard, the heat exchanger 106 has an inlet where a heat transfer medium can be added if desired or required.

As the heat transfer medium flows through the heat exchanger 106 and extracts energy from the phase change material 110, the energy can be used in conjunction with a Brayton cycle generator or turbine. Turbines are well known in the art, and those skilled in the art will appreciate that any turbine or device that can produce electricity from a flowing heat transfer material can be used with the energy storage apparatus 100.

### Example 3—Thermal Heating of Energy Storage Apparatus

Referring to FIG. 2b, the energy storage apparatus 100 comprises a crucible 102. A heating element is placed (not shown) external to the energy storage apparatus 100.

FIG. 2b shows an energy storage array 114 having eight energy storage apparatus 100. The energy storage array 114 can be used within a container such as a shipping container for easy transport and effective housing.

The phase change material 110 is located within the crucible 102 such that when the crucible 102 is heated by the thermal heating element 112, the thermal energy is directly transferred to the phase change material 110 to store energy. This is provided by one circuit of the heat exchanger 106. The heating element 112 heats the heat transfer medium which radiates through the crucible 102 to store energy.

A separate independent circuit of the heat exchanger 106 is encased within the crucible 102 so that it can extract the thermal energy from the phase change material 110. The heat exchanger 106 can be a high pressure pipe network which facilitates extraction of the thermal energy from the phase change material 110 and converting said thermal energy to electricity.

Similar to Example 2, the energy can be used in conjunction with a Brayton generator or turbine to produce electricity.

### Example 4—Electrical Heating of Energy Storage Apparatus within Crucible

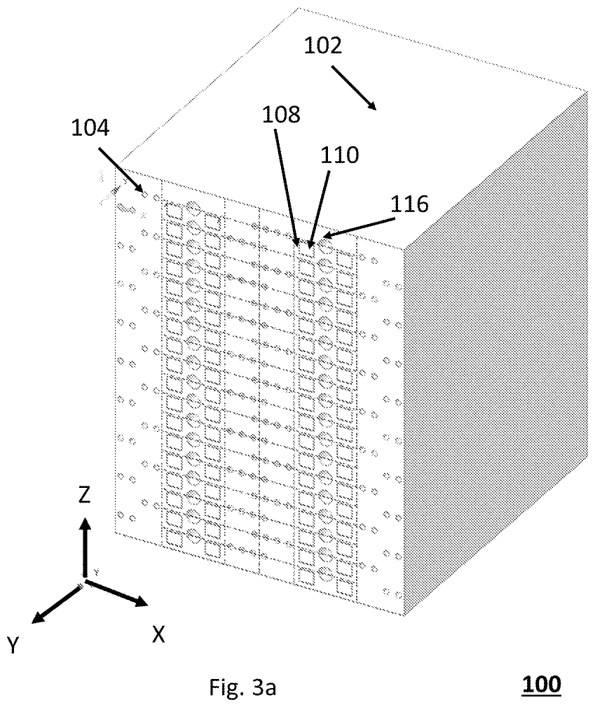

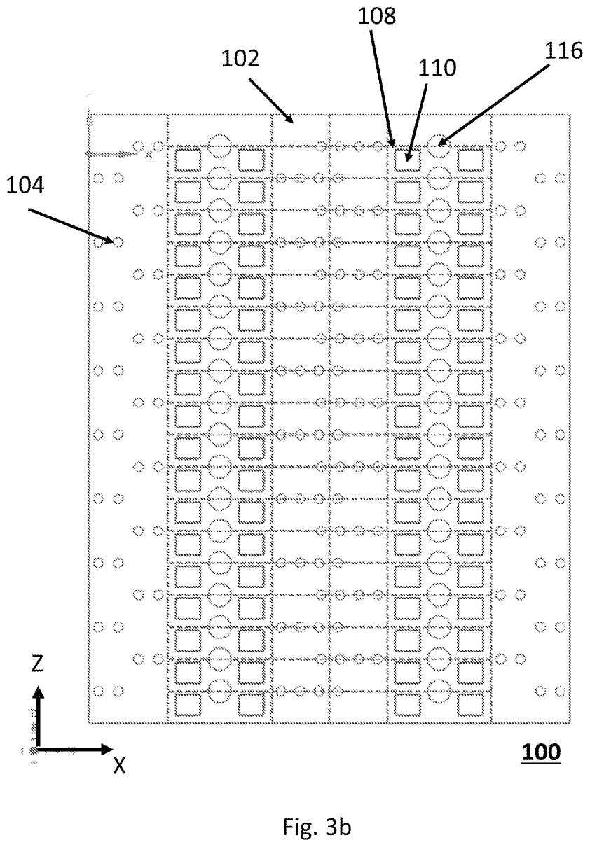

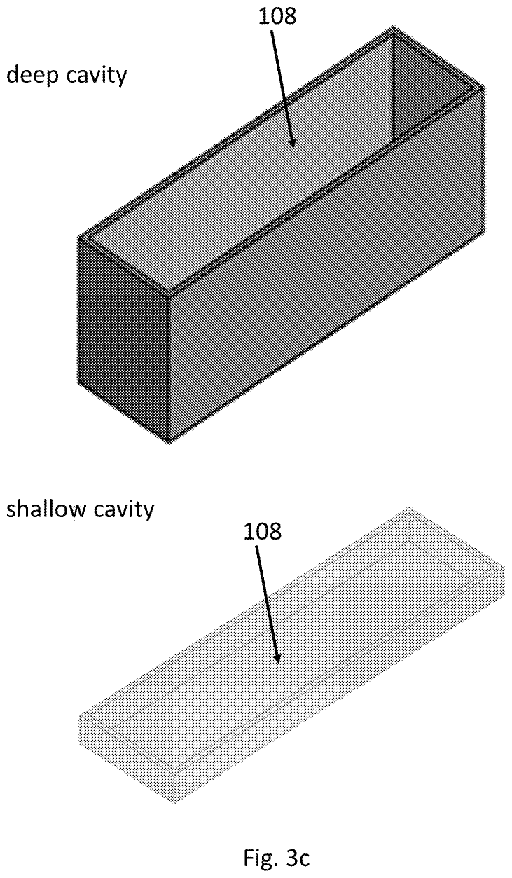

Referring to FIG. 3a, the energy storage apparatus 100 comprises a crucible 102, where the crucible is assembled by component parts preferably made of graphite having a cavity 108 to store the phase change material 110, a channel 104 to receive the heat exchanger 106 (not shown) and a heating element channel 116 to receive the heating element 112 (not shown). A series of heating element channels is provided to receive a plurality of heating elements 112. The heating element 112 is internal to the energy storage apparatus 100 and more particularly within the crucible 102. The heating element 112 is in heating communication with the crucible 102 in order to heat the crucible 102 and phase change material 110. The heating element 112 is in the form of electrical resistors which can be inserted into the heating element channel 116 and optionally the heating element can mechanically engage with the heating element channel to lock the heating element in the energy storage apparatus.

The phase change material 110 is located within the crucible 102 such that when the crucible 102 is heated by the internal heating elements 112, the thermal energy is transferred to the phase change material 110 to store energy. The heat exchanger 106 is encased within the crucible 102 so that it can extract the thermal energy from the phase change material 110 when required. The heat exchanger 106 can be a high pressure pipe network which facilitates storing and/or extraction of the thermal energy from the phase change material 110 and converting said thermal energy to electricity. The heat exchanger 106 has an inlet and an outlet. The inlet of the heat exchanger 106 is generally connected to a high pressure pump (not shown) and the outlet will generally be connected to a turbine (not shown). In this regard, the heat exchanger 106 has an inlet where a heat transfer medium or a supercritical fluid can be added if desired or required.

As the heat transfer medium flows through the heat exchanger 106 and extracts energy from the phase change material 110, the energy can be used in conjunction with a Brayton cycle generator or turbine. Turbines are well known in the art, and those skilled in the art will appreciate that any turbine or device that can produce electricity from a flowing heat transfer material can be used with the energy storage apparatus 100.

The phase change material 110 is located between the heating element channel 116 which receives the heating element 112 (not shown) and the channel 104 which receives the heat exchanger 106. In this configuration, the phase change material advantageously provides a thermal barrier between the heating element 112 and the heat exchanger 106 to avoid overheating the heat exchanger and exceeding the heat exchanger materials temperature limit of operation.

The heat exchanger 106 operates at high temperature and high pressure for sCO₂ Brayton Cycle generators, typically 100-250 bar or greater and from 500° C. to 800° C. or higher. The pressure is generally fixed during operation and therefore to avoid the heat exchanger 106 from reaching or exceeding the maximum rated operating temperature, the temperature of the heat exchanger 106 is managed and controlled.

The energy storage apparatus 100 of the present invention can be charged (storing thermal energy) during periods of excess or cheap renewable energy (for example, during peak daylight hours). Typically, there is a 4-hour window to fully charge the energy storage apparatus 100. To minimise charge time, it is desirable to maximise heating element 112 power and maximise heating element 112 temperature.

By having a phase change material thermal barrier (‘wall’) between the heating element 112 and the heat exchanger 106, the heat rate of the heat exchanger 106 slows as it nears the temperature limit as the phase change material 110 is absorbing latent heat making the temperature rise at the pipes easier to control and manage.

FIG. 3b is a front view of the embodiment of the energy storage apparatus of FIG. 3a.

FIG. 3c shows an embodiment of a component of a deep and shallow cavity 108 graphite crucible component, respectively. The cavity crucible component can be designed to wholly contain/store the phase change material 110 (not shown) and ameliorates or prevents seepage of molten aluminium 110 to contact the heat exchanger 106 (not shown). The cavity crucible component can be assembled together with other crucible components such as a heat exchanger channel crucible component and heating element channel crucible component to form the overall crucible 102.

### Example 5—Material Selection for sCO₂ Heat Exchanger Piping

The Applicant has evaluated 20 potential heat exchanger materials suitable for supercritical CO₂ based on the following operating criteria:
Temperature between 500 to 800° C.;
Pressure from 100 to 250 bar (and above)
sCO₂ and air as heat transfer fluids; and
Heat exchanger piping embedded in solid graphite crucible.

In order to determine the suitability, each of the heat exchanger materials was evaluated and ranked with regards to their temperature/pressure performance, carburisation resistance, weldability, bendability, availability, cost, compatibility with sCO₂ and compatibility with molten aluminium. The materials shortlisted and ranked based on the above criteria (in descending order) are alloys 625, 740H, 230, 617 and 800HT. However, depending on application of the energy storage apparatus, the other heat exchanger materials may also be suitable for use in the energy storage apparatus of the present invention.

The following alloy materials are preferred:
625 is a preferred heat exchanger material due to its high ranking in most categories;
740H is another preferred heat exchanger material due to its high allowable stress at operating temperature;
230 remains in consideration as a substitute for 740H;
617;
800HT remains in consideration for lower temperature and pressure applications, due to its low comparative cost and ready availability, this material is suitable if the temperature and pressure of the application are reduced and extent of carburisation can be quantified.

As would be appreciated by a person skilled in the art, the selection of a heat exchanger material can depend on the operating parameters of the energy storage apparatus. The preferred heat exchanger material can be application dependent due to factors such as operating conditions, project requirements and manufacturing environment. However, energy storage apparatus of the present invention is largely indifferent to heat exchanger material selection (i.e. only minor design changes are required for a different piping material).

To maximise energy conversion efficiency when the energy storage apparatus is used for supercritical fluids such as sCO₂, the energy storage apparatus can be operated between 500 to 800° C. (and potentially above) and from 100 to 250 bar (and potentially above).

The heat exchanger piping is embedded in the solid graphite (assembled by component parts) and is used as the conduit for heat extraction, with sCO₂ and air considered for the heat transfer fluids (HTFs) at these high temperature and pressure conditions.

The energy storage apparatus of the present invention can be designed to comply with the following standards, ASME BPVC (relevant sections), ASME B31.3 and EU Pressure equipment Directive PED 2014/68/EU.

As the heat exchanger piping is in contact with graphite at high temperatures, the material is preferably carburisation resistant.

The Applicant is developing a modular system to store thermal energy in a solid graphite medium, with temperatures up to 800° C. (can be pressure dependant). The system is indifferent to energy input, i.e. it can accept electrical input from surplus or curtailed renewable energy sources such as wind or photovoltaics; or it can accept direct thermal energy input from sources such as concentration solar thermal (CST), process/waste heat or a dedicated HTF, amongst others. The stored thermal energy can then be extracted via a HTF passing through heat exchanger piping embedded in the graphite to drive a turbine directly, or act as an intermediate HTF depending on system requirements.

One of the advantages of the energy storage apparatus of the present invention is its operating simplicity during both energy charge and discharge. Another advantage is the integration of the energy storage device and heat exchanger, eliminating the need for an intermediate heat exchanger between the energy storage and process flow.

The “units” of the energy storage module are described below:
Energy storage apparatus: unit comprising graphite crucible and phase change material for energy storage and heat exchangers (FIGS. 1 and 3).
Array: configuration of a plurality of energy storage apparatus including instrumentation in a 20′HC (20 foot high cube container) volume (FIG. 2).
Module: flexible arrangement of arrays designed to maximise output temperature for desired storage discharge duration.
System: arrangement of modules optimised for the selected turbine and operation model (FIG. 4).

The system and units are shown in FIG. 4.

The energy storage apparatus can also function as a heat exchanger between a solid graphite storage medium and the HTF (air or sCO₂ in this embodiment). Representative embodiments for the assembly of the energy storage apparatus are shown in FIGS. 1 and 3.

### Example 6—Assessing Benefits of Aluminium as Phase Change Material

This Example quantifies the benefits associated with enclosing aluminium (as the phase change material) in a graphite crucible, with varying aluminium to graphite ratios, to be utilised as a high temperature thermal storage medium optimised to the requirements of emerging supercritical CO₂ Brayton cycle generators. The aluminium will be enclosed or surrounded by graphite (not encapsulated, bound or incorporated in—that is sealed in the cavity of the crucible).

Increasing the aluminium volumetric ratio increases the total mass and thermal storage capacity of the system, while decreasing the storage material cost (within the temperature range of 400-1000° C.).

Storing thermal energy as latent heat using a phase change material (PCM) has many advantages over sensible heat storage, including: high heat storage density at a target temperature range and low storage volume/weight.

The low thermal conductivity of available PCMs has hindered their application and commercialisation. Metallic PCMs result in effective storage systems due to high thermal conductivity. Aluminium has been selected as a preferred embodiment of the PCM for the energy storage apparatus of the present invention due to the following: (a) high thermal conductivity; (b) low cost; (c) suitable meting temperature (600-680° C.); (d) well characterised and predictable thermal properties; and (e) readily available commercially.

In this Example, the following assumptions have been made: (a) aluminium density does not vary with temperature, the value utilised assumes standard atmospheric conditions at ‘room temperature’; (b) aluminium specific heat capacity does not vary with temperature, the value utilised assumes standard atmospheric conditions at ‘room temperature’; and (c) the thermal energy storage operational temperature range is from 400-1000° C.

In this Example, comparisons have been completed to assess mass and volume ratios of aluminium to graphite. For mass ratio comparison, the total storage mass has been assumed to be 1 tonne and for volume ratio comparison, the total storage volume has been assumed to be 1 m³.

The cost of thermal energy storage has been predicted at different aluminium-graphite ratios assuming a cost of USD $2/kg for Aluminium and $4/kg for Graphite in the present Example, unless stated otherwise.

TABLE 9
Material Properties of Aluminium and Graphite

| Property | Unit | Graphite | Aluminum |
|---|---|---|---|
| Density | (tonne/m³) | 1.70 | 2.70 |
| Cp | (kJ/kg · K) | 1.19-2.04* | 0.91 |
| Latent Heat | (kJ/kg) | N/A | 397* |
| of Fusion | | | |
| Thermal | (W/m · K) | 60-120 | Solid: 206, |
| Conductivity | | | Liquid: 92 |
| Melting | (° C.) | N/A | 660 |
| Temperature | | | |
| Cost | $USD/kg | 4 | 2 |

*latent heat of fusion within the range of 320-400 kJ/kg.

Comparisons have been made to assess mass and volume ratios of aluminium to graphite. The following has been assessed: (a) thermal storage capacity (kWh); and (b) storage cost ($).

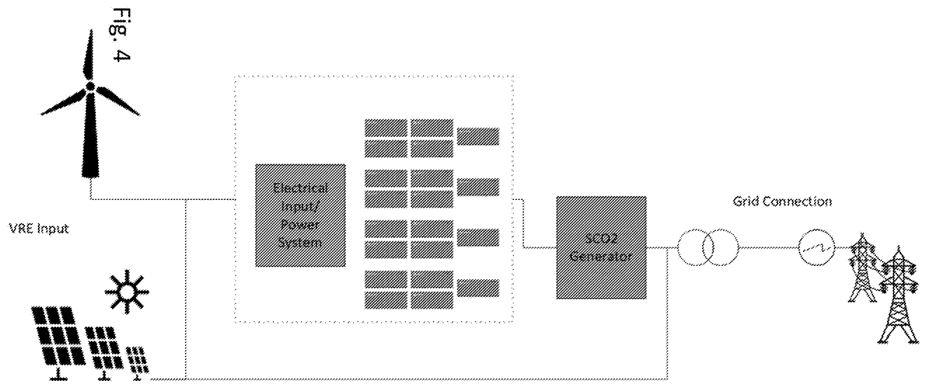

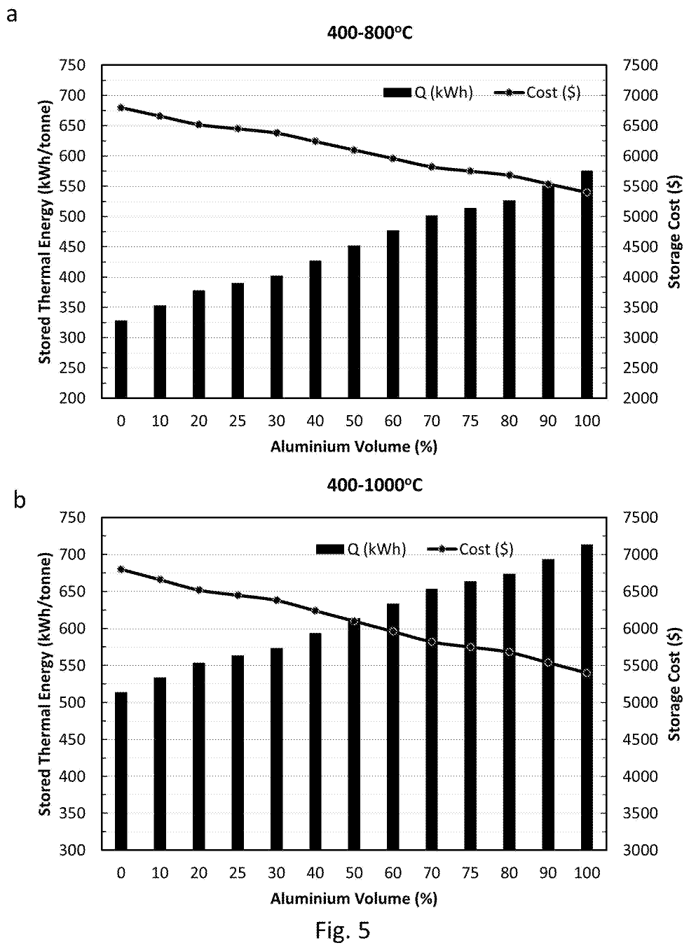

The volume ratio comparison is of most interest, as it is more practical to designing energy storage apparatus on volume ratio as opposed to mass ratio. Recycled aluminium is cheaper per kg than graphite, as volume % of aluminium increases, the cost of thermal energy stored reduces. The wider the operating temperature range the higher the amount of stored thermal energy lowering the cost per kWh stored. This is exemplified in FIG. 5. FIG. 5 shows volume ratio comparison of energy storage using aluminium between a temperature of about 400-800° C. and about 400-1000° C.

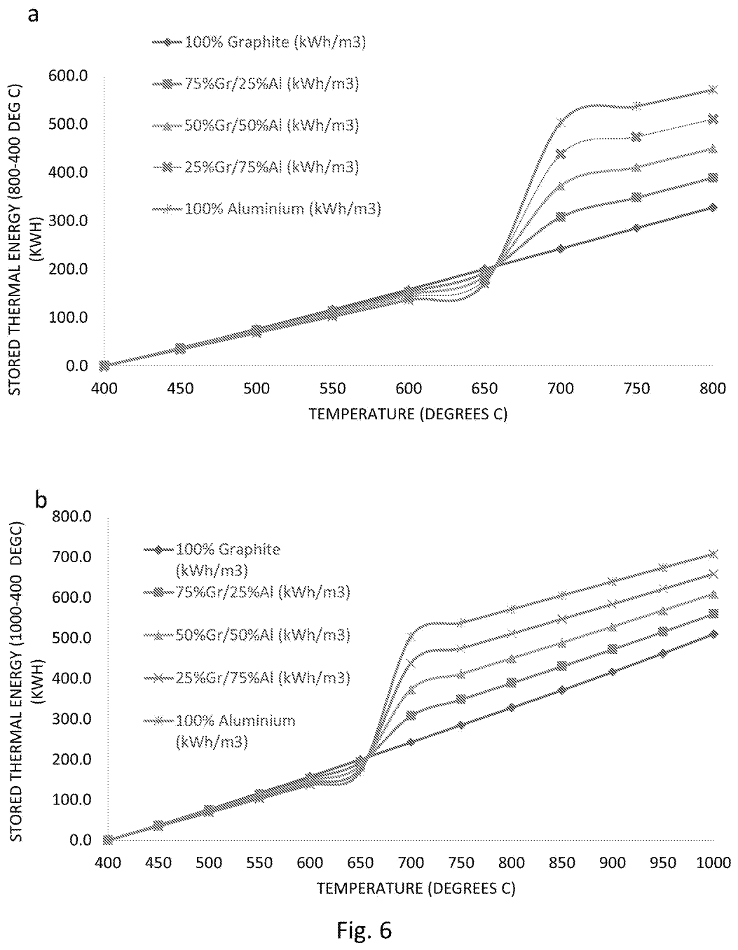

FIG. 6 shows volume ratio comparison of energy storage using aluminium between a temperature of about 400-800° C. and about 400-1000° C. at different relative amounts of aluminium to graphite (wt %). Tables 10-12 shows an analysis summary of the volume ratio comparison, material price and density.

As FIG. 6 shows, by including latent heat with sensible heat thermal energy storage, the energy density of the energy storage apparatus can be increased and provides for ‘tuning’ the discharge temperature of the HTF to bias certain temperature ranges that are beneficial to the working fluid and generator cycles e.g. sCO₂ in Brayton cycle generators.

TABLE 10
Volume ratio comparison of different amounts
of graphite to aluminium (wt %).

| | | (400-800° C.) | | (400-1000° C.) | |
|---|---|---|---|---|---|
| | | Thermal | | Thermal | |
| | Cost for 1 m³ | Storage | | Storage | |
| Volume | (storage | Capacity | | Capacity | |
| Ratio | medium only)* | (1 m³) | $/kWhₜₕ | (1 m³) | $/kWhₜₕ |
| 100% Gr | $ 6,800 | 328 kWhₜₕ | $ 20.70 | 510 kWhₜₕ | $ 13.30 |
| 0% Al | | | | | |
| 75% Gr | $ 6,450 | 389 kWhₜₕ | $ 16.60 | 560 kWhₜₕ | $ 11.50 |
| 25% Al | | | | | |
| 50% Gr | $ 6,100 | 450 kWhₜₕ | $ 13.60 | 609 kWhₜₕ | $ 10.00 |
| 50% Al | | | | | |
| 25% Gr | $ 5,750 | 497 kWhₜₕ | $ 11.60 | 659 kWhₜₕ | $ 8.70 |
| 75% Al | | | | | |
| 0% Gr | $ 5,400 | 572 kWhₜₕ | $ 9.50 | 708 kWhₜₕ | $ 7.60 |
| 100% Al | | | | | |

TABLE 11
Material price comparison of different amounts of graphite to aluminium (wt %).

| | Cost for | | Cost for | | Cost for | | Cost for | |
|---|---|---|---|---|---|---|---|---|
| | 1 m³ | (400- | 1 m³ | (400- | 1 m³ | (400- | 1 m³ | (400- |
| Volume | Al: $2/kg | 1000° C.) | Al: $3/kg | 1000° C.) | Al: $1.5/kg | 1000° C.) | Al: $2/kg | 1000° C.) |
| Ratio | Gr: $4/kg | $/kWhₜₕ | Gr: $4/kg | $/kWhₜₕ | Gr: $4/kg | $/kWhₜₕ | Gr: $3/kg | $/kWhₜₕ |
| 100% Gr | $ 6,800 | $ 13.30 | $ 6,800 | $ 13.30 | $ 6,800 | $ 13.30 | $ 5,100 | $ 10.00 |
| 0% Al | | | | | | | | |
| 75% Gr | $ 6,450 | $ 11.50 | $ 7,150 | $ 12.70 | $ 6,100 | $ 10.90 | $ 5,150 | $ 9.20 |
| 25% Al | | | | | | | | |
| 50% Gr | $ 6,100 | $ 10.00 | $ 7,450 | $ 12.20 | $ 5,450 | $ 9.00 | $ 5,250 | $ 8.60 |
| 50% Al | | | | | | | | |
| 25% Gr | $ 5,750 | $ 8.70 | $ 7,750 | $ 11.80 | $4,750 | $ 7.20 | $ 5,350 | $ 8.10 |
| 75% Al | | | | | | | | |
| 0% Gr | $ 5,400 | $ 7.60 | $ 8,100 | $ 11.40 | $4,050 | $ 5.70 | $ 5,400 | $ 7.60 |
| 100% Al | | | | | | | | |

TABLE 12
Density comparison of different amounts of graphite to aluminium (wt %).

| | Cost for | | Cost for | | Cost for | | Cost for | |
|---|---|---|---|---|---|---|---|---|
| | 1 m³ | (400- | 1 m³ | (400- | 1 m³ | (400- | 1 m³ | (400- |
| Volume | Al: 2.7 t/m³ | 1000° C.) | Al: 2.2 t/m³ | 1000° C.) | Al: 2.7 t/m³ | 1000° C.) | Al: 2.2 t/m³ | 1000° C.) |
| Ratio | Gr: 1.7 t/m³ | kWhₜₕ | Gr: 1.7 t/m³ | kWhₜₕ | Gr: 1.8 t/m³ | kWhₜₕ | Gr: 1.8 t/m³ | kWhₜₕ |
| 100% Gr | $ 6,800 | 510 | $ 6,800 | 510 | $ 7,200 | 540 | $ 7,200 | 540 |
| 0% Al | | | | | | | | |
| 75% Gr | $ 6,450 | 560 | $ 6,200 | 527 | $ 6,750 | 582 | $ 6,500 | 549 |
| 25% Al | | | | | | | | |
| 50% Gr | $ 6,100 | 609 | $ 5,600 | 544 | $ 6,300 | 624 | $ 5,800 | 559 |
| 50% Al | | | | | | | | |
| 25% Gr | $ 5,750 | 659 | $ 5,000 | 560 | $ 5,850 | 666 | $ 5,100 | 568 |
| 75% Al | | | | | | | | |
| 0% Gr | $ 5,400 | 708 | $ 4,400 | 577 | $ 5,400 | 708 | $ 4,400 | 577 |
| 100% Al | | | | | | | | |

Tables 13 and 14 show the relative costs for energy storage of an energy storage apparatus of an embodiment of the invention and a module comprising an array of energy storage apparatus of the present invention, respectively.

TABLE 13
Relative costs for energy storage of an embodiment
of an energy storage apparatus.

| | Storage | Cost (storage | Thermal Storage | |
|---|---|---|---|---|
| Volume | Volume | medium only)* | Capacity | |
| Ratio | (m³) | ($) | (400-800° C.) (kWh) | $/kWh |
| 100% Gr | 1.29 | $ 8,760 | 424 | $ 20.70 |
| 0% Al | | | | |
| 75% Gr | 1.29 | $ 8,310 | 501 | $ 16.60 |
| 25% Al | | | | |
| 50% Gr | 1.29 | $ 7,860 | 580 | $ 13.60 |
| 50% Al | | | | |

The most economical $/kWh/m³ of Aluminum-Graphite thermal storage is 100% aluminum. However, from a manufacturability point of view, a 100% aluminum storage medium is not practical due to the requirement to allow free thermal expansion of the heat exchanger pipework. It is envisaged that approximately up to 50% aluminum volume ratio is the preferred embodiment.

TABLE 14
Relative costs for energy storage of an embodiment of
module comprising an array of energy storage apparatus.

| | Storage | Cost (storage | Thermal Storage | |
|---|---|---|---|---|
| Volume | Volume | medium only)* | Capacity | |
| Ratio | (m³) | ($) | (400-800° C.) (kWh) | $/kWh |
| 100% Gr | 10.30 | $ 70,070 | 3390 | $ 20.70 |
| 0% Al | | | | |
| 75% Gr | 10.30 | $ 66,460 | 4008 | $ 16.60 |
| 25% Al | | | | |
| 50% Gr | 10.30 | $ 62,850 | 4637 | $ 13.60 |
| 50% Al | | | | |

Increasing the aluminum ratio (while maintaining constant thermal storage volume) increases the total mass and thermal storage capacity of the system, while decreasing the storage medium cost. As increasing the volume of aluminum increases the thermal storage capacity of the system, the price of aluminum would have to exceed the price of graphite for the system to become uneconomical.

### Example 7—Modelling Properties of Heat Transfer Fluid (HTF)

An embodiment of the energy storage apparatus was modelled to measure the performance of the energy charge/discharge and flow rate using a heat transfer fluid. The following design parameters were assumed:
Approximately 8 m³ panel (˜2m×2m×2m)
Approximately 10 tonne of graphite/PCM;
Approximately 160 m total of DN25 Sch80 HX heat exchanger pipe;
With and without PCM (AlSi12 and Al);
Heat exchanger temperature maintained below 700° C. for ASME B31.3 compliance; and
% PCM, 0 v/v %, 15 v/v % and 30 v/v % of phase change material relative to total volume of panel.

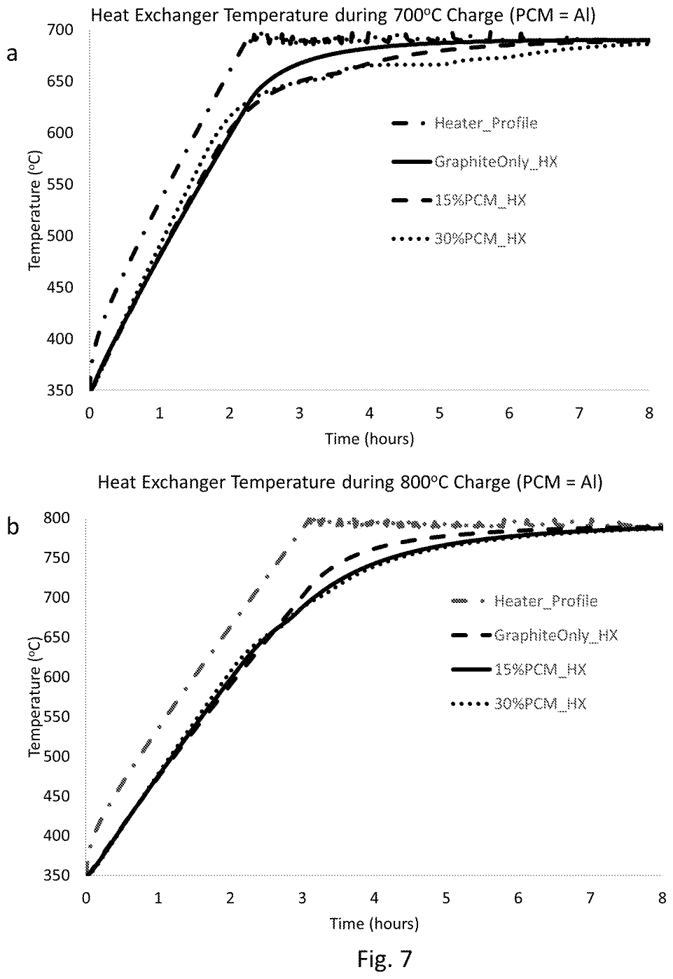

FIG. 7 shows the temperature of the heat exchanger as an embodiment of the energy storage apparatus is being charged. FIG. 7(a) shows the heater temperature is set at maximum of 700° C. and total power of 522 kW. Maximum heat exchanger pipe temperature of 675° C. is reached after 5 hours of charging. FIG. 7(b) shows heater temperature is set at maximum of 800° C. and total power of 522 kW. Maximum heat exchanger pipe temperature of 675° C. is reached under 3 hours of charging with no aluminium PCM. However, with aluminium PCM the temperature rise slope flattens allowing more time for the heater controls to respond.

A representative scenario of thermal energy storage and discharge with average outlet temperature of a heat transfer fluid modelled is shown in Table 15.

TABLE 15
Thermal energy storage and discharge with average
outlet temperature of a heat transfer fluid

| | | Energy | Energy | | Average |
|---|---|---|---|---|---|
| | Flow | In | Out | % | Temperature |
| Scenario | (kg/s) | (kWh) | (kWh) | Out/In | Out |
| AlSi12 | 0.5 | 640 | 379 | 59% | 550° C. |
| AlSi12 | 1 | 640 | 453 | 71% | 490° C. |
| Aluminium | 0.5 | 596 | 394 | 69% | 556° C. |
| Aluminium | 1 | 596 | 452 | 79% | 490° C. |
| Graphite | 0.5 | 647 | 448 | 66% | 577° C. |
| Only | | | | | |
| Graphite | 1 | 647 | 512 | 76% | 502° C. |
| Only | | | | | |

* HTF/working fluid = supercritical CO₂ used to extract heat from energy storage apparatus

### Example 8—Phase Change Material Kiln Tests

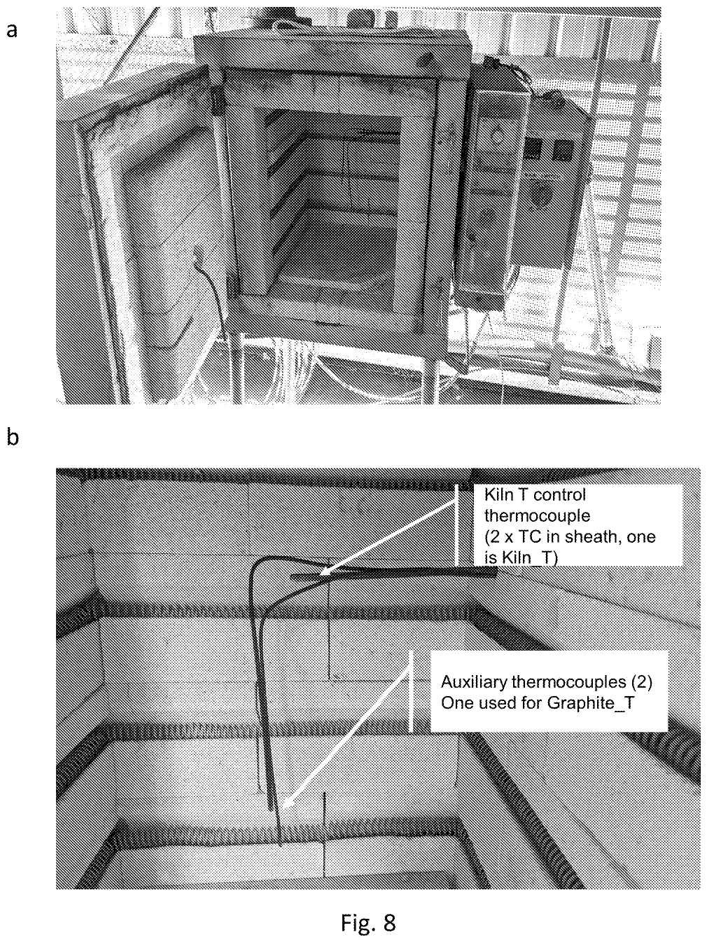

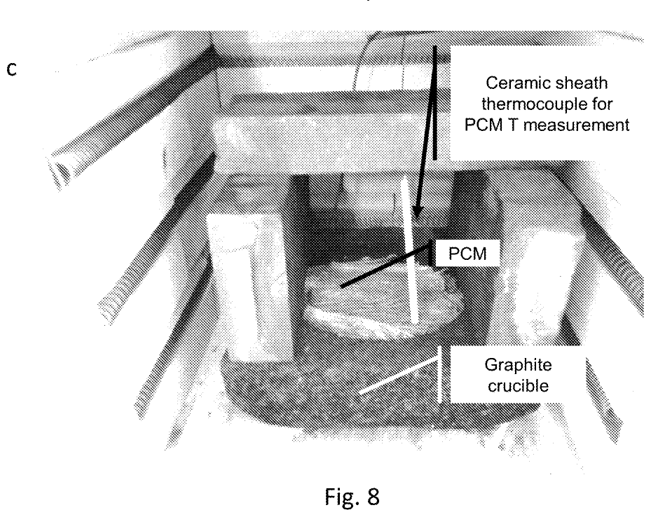

In this Example, phase change material (aluminium) was tested in a kiln. A kiln (Condoblin) was used to achieve the required test temperatures of ˜900° C. in air. The kiln was modified to incorporate the addition of a datalogger. The kiln was configured to allow the testing of the melting and freezing behaviour of various phase change materials in a graphite crucible to demonstrate the validity incorporating PCM in the energy storage apparatus of the present invention. An Argon inlet system was added to the door of the kiln, an oxygen sensor installed in the exhaust flue and a new seal was mounted for the door. The oxygen sensor was the standard Bosch wide range automotive sensor and Knödler conditioning card. The kiln setup is shown in FIG. 8. FIG. 8(c) shows the configuration of the test using wire, the graphite T thermocouple (not shown) is embedded in the crucible and the crucible was oxidised from prior kiln heating tests. Testing showed that the graphite oxidised at high temperatures (˜680° C.) in air (non-inert atmosphere). Initial testing showed the kiln capable of rapidly achieving the desired test conditions.

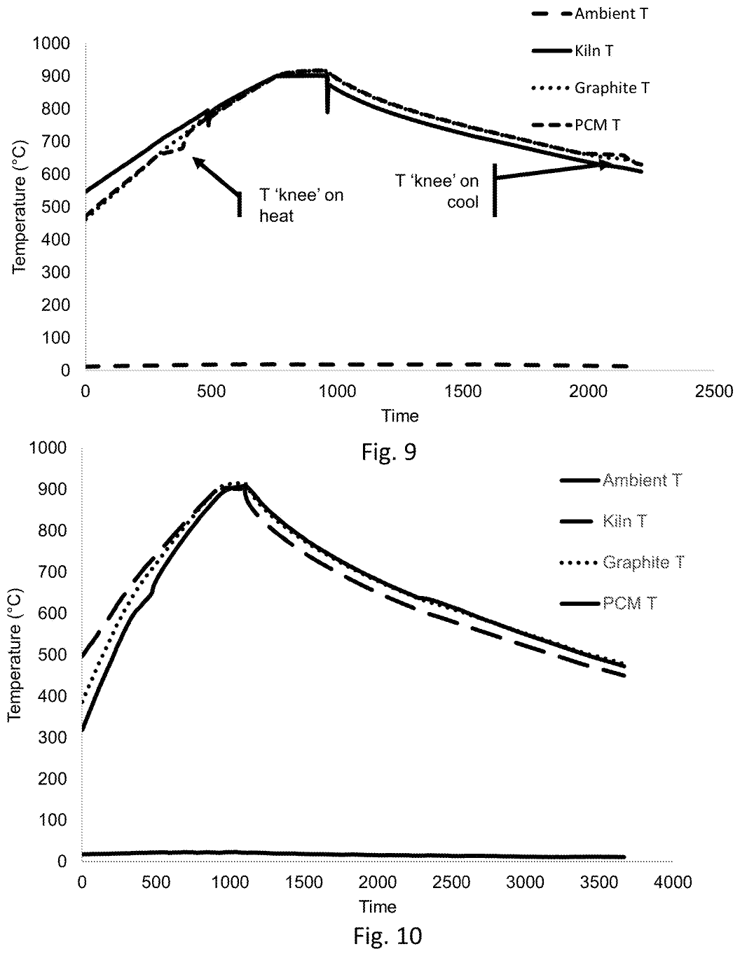

A first series of tests for heating tests to validate the data logging and kiln temperature control showed a clear “knee” on heating and cooling of the phase change material in a graphite crucible indicating phase change at the expected temperature of ˜679° C. This is shown in the heat and cool traces in FIG. 9. In this test, the aluminium wire did not appear to fully melt after testing which the inventors believe is a result of the oxide layer on the wire maintaining its tubular form as the aluminium inside melted and then ‘froze’ (i.e., solidified).

A second series of tests was performed using a 20 mm thick aluminium plate to observe the behaviour of solid aluminium pieces as phase change material and further to verify argon flow (3 L/min) and oxygen sensing with a graphite lid. Similar results were observed as above as shown in FIG. 10 with a steeper gradient in the heating and cooling curves, but still a clear knee temperature on heating and cooling of ˜640° C. The second series of tests showed the graphite lid performed acceptably, although oxygen concentration was high so subsequent tests are to be run at ˜6 L/min Argon flow. The PCM final diameter was smaller than the crucible diameter indicating it shrunk away from the walls after it solidified and before it cooled (diameter of cooled aluminium 186 mm compared to crucible diameter at 190 mm).

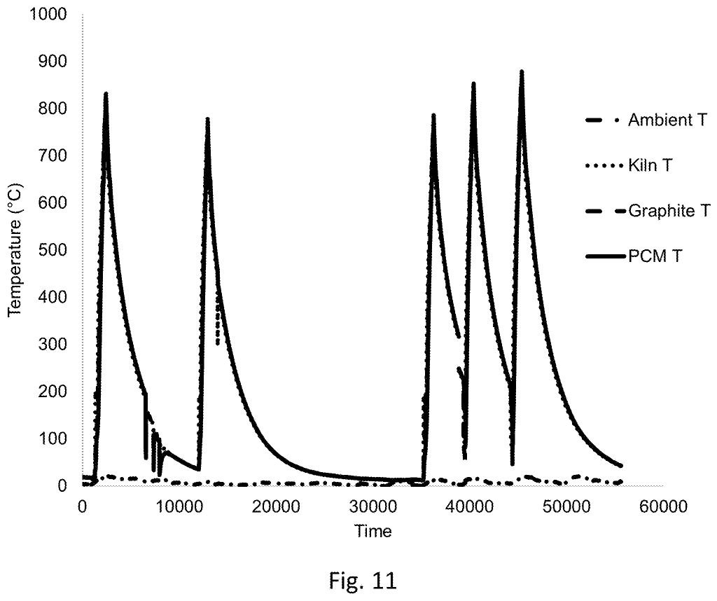

A third series of tests was performed using an aluminium rod (purchased from Collier and Miller Griffith) with an argon flow at ˜6 L/min. The purpose of this test was to acquire test data for thermal modelling calibration. A clear “knee” on heating and cooling of the phase change material in a graphite crucible was observed at a temperature of ˜656° C. The graphite crucible was machined into two blocks, each block having a dimension (mm) 185(w)×150(d)×90(d). The base crucible had a hole Ø80 and depth 50 while the lid had a hole Ø80 and depth 35. As shown in FIG. 11, five tests were performed over two weeks and showed consistent melting point of aluminium phase change material. Table 16 shows the results of the heating and cooling cycles of this third series of tests.

TABLE 16
Heating and cooling cycle results

| | | | | | Heat T |
|---|---|---|---|---|---|
| | | Start Mass | End Mass | Mass Loss | ‘Knee’ |
| Run | Date | (g) | (g) | (%) | (° C.) |
| 1 | 2020 Apr. 28 | Base 4126; | Base 4073; | Base 1.28%; | 658° |
| | | Lid 4304; | Lid 4236; | Lid 1.58%; | |
| | | Al 409 | Al 407 | Al 0.49% | |
| 2 | 2020 Apr. 30 | Base 4073; | Base 4565 | | 655° |
| | | Lid 4236; | Lid (+Al) | | |
| | | Al 407 | 4968 | | |
| 3 | 2020 May 5 | Base 4565 | Base 4522 | Base 0.94% | 656° |
| | | Lid (+Al) | Lid (+Al) | | |
| | | 4968 | 4955 | | |
| 4 | 2020 May 6 | Base 4522 | Base 4455 | 1.48% | 657° |
| | | Lid (+Al) | Lid (+Al) | | |
| | | 4955 | 4065 | | |
| 5 | 2020 May 7 | Base 4455 | To Be | | 655° |
| | | Lid (+Al) | Measured | | |
| | | 4065 | | | |

The mass measurements were variable which the inventors believe may be due to the thermocouple still being embedded in the PCM. Mass changes of greater than 5% have been ignored.

Those skilled in the art will appreciate that the invention described herein is susceptible to variations and modifications other than those specifically described. It is understood that the invention includes all such variations and modifications which fall within the spirit and scope of the present invention.

1. An energy storage apparatus comprising:
a crucible having a cavity and a channel having at least two open ends within the body of the crucible;
a phase change material stored in the cavity of the crucible; and
a heat exchanger having an inlet and an outlet, wherein at least a portion of the heat exchanger is encased within the channel.

2. (canceled)

3. The energy storage apparatus according to claim 1, comprising a plurality of crucibles.

4. The energy storage apparatus according to claim 1, wherein the crucible comprises an open cavity.

5. The energy storage apparatus according to claim 1, wherein the crucible comprises a closed cavity.

6. The energy storage apparatus according to claim 1, wherein the crucible comprises a plurality of cavities.

7. The energy storage apparatus according to claim 1, wherein the crucible comprises one or more channels along an outer surface of the crucible body, wherein a portion of the heat exchanger is disposed along at least one of the one or more channels.

8. (canceled)

9. (canceled)

10. The energy storage apparatus according to claim 1, wherein the material of the crucible is selected from the group consisting of silicon carbide, graphite, reinforced polymer, clay, porcelain, ceramics, carbon nanotubes, aluminium nitride, aluminium oxide, boron nitride, silicon nitride, steel, copper, mullite, zirconium oxide, ductile iron, cast iron, stainless steel, brass, alloys of columbian, tantalum, molybdenum, tungsten and combinations thereof.

11. (canceled)

12. (canceled)

13. The energy storage apparatus according to claim 1, wherein the energy storage apparatus stores energy using a heating element.

14. The energy storage apparatus according to claim 13, wherein the heating element is selected from the group consisting of a heliostat, a furnace, an electrical resistor, a heat transfer fluid and combinations thereof.

15. The energy storage apparatus according to claim 13, wherein the heating element is internal to the energy storage apparatus.

16. The energy storage apparatus according to claim 13, wherein the energy storage apparatus comprises a plurality of heating elements.

17. (canceled)

18. The energy storage apparatus according to claim 1 wherein the energy storage apparatus comprises a plurality of heat exchangers.

19. The energy storage apparatus according to claim 18, wherein each heat exchanger is a separate independent circuit.

20. (canceled)

21. The energy storage apparatus according to claim 1, wherein the phase change material is a metal or a metal alloy.

22. The energy storage apparatus according to claim 21, wherein the phase change material is aluminium, or an alloy comprising aluminium.

23. A method of reversibly storing and/or extracting energy comprising the steps of:
providing an energy storage apparatus as defined according to claim 1;
heating the phase change material to induce a phase change thereby storing latent energy; and
extracting energy by flowing a heat transfer medium having a temperature below a temperature of the phase change material such that energy is transferred from the phase change material to the heat transfer medium,
thereby providing reversible energy storage and extraction.

24. (canceled)

25. The method according to claim 23, wherein the temperature of the heat transfer medium is below the phase change temperature of the phase change material.

26. (canceled)

27. The method according to claim 25, comprising heating the crucible of the energy storage apparatus to heat the phase change material.

28. An energy storage array comprising: a plurality of energy storage apparatus according to claim 1 in thermal and/or electrical communication.

29.-31. (canceled)

32. The energy storage array according to claim 28, wherein the array is arranged in series or parallel.
